(19) United States
(12) Patent Application Publication
(10) Pub. No.: US 2011/0216412 A1
(43) Pub. Date: Sep. 8, 2011

(54) MASTER TOOLS WITH SELECTIVELY ORIENTABLE REGIONS FOR MANUFACTURE OF PATTERNED SHEETING

(76) Inventors: David Reed, (US); John Nelson, The Sea Ranch, CA (US)

(21) Appl. No.: 13/040,250

(22) Filed: Mar. 3, 2011

Related U.S. Application Data
(60) Provisional application No. 61/311,088, filed on Mar. 5, 2010.

(51) Int. Cl. G02B 5/124; B29C 59/02

(52) U.S. Cl. 359/530; 425/385; 264/293

(57) ABSTRACT

In one embodiment of the invention, a master tool is disclosed including a top plate, a plurality of buttons, and a releasable locking mechanism. The top plate has an array of openings and a top side with a background patterned surface. The plurality of buttons are in the array of openings and configured to be repositioned to selectively orient their orientable patterned surface into a different orientation with respect to the background patterned surface. The releasable locking mechanism releasably locks the position of the plurality of buttons within the array of openings to hold the selected orientation of each orientable patterned surface with respect to the background patterned surface to provide a top surface pattern. The top surface pattern of the master tooling may be transferred to form a surface pattern into retro-reflective sheeting during its manufacture.

### CROSS-REFERENCE TO RELATED APPLICATIONS

This non-provisional United States (U.S.) patent application claims the benefit of U.S. Provisional Patent Application No. 61/311,088 entitled MASTER TOOLS AND PATTERNED SHEETING WITH PERIODIC ROTATED PATTERNED REGIONS filed on Mar. 5, 2010 by David Reed et al., which is incorporated here by reference.

### FIELD OF THE INVENTION

The embodiments of the invention relate generally to tools for the manufacture of patterned retro-reflective sheeting.

### BACKGROUND

Design tools to manufacture a pattern into retro-reflective sheeting include square cylindrical pins bundled together. Each of the pins have a top corner cube surface forming a part of an array of corner cubes that may be used to manufacture a pattern into retro-reflective sheeting. Cutting the top corner cube surface into each pin is rather time consuming. Furthermore, bundling each pin together in proper order and alignment in the array of corner cubes is further time consuming. If there is a change to the design, the time consuming processes of cutting the top surface of the pins and the bundling of the pins together may need repeating. Thus, the time to market a new design for retro-reflective sheeting may be long.

It is desirable to provide a new design tool that can be used to shorten the design cycle of different patterns for the manufacture of patterned retro-reflective sheeting to meet various retro-reflection design goals or specifications.

### BRIEF SUMMARY

The embodiments of the invention are best summarized by the claims that follow below.

### BRIEF DESCRIPTION OF THE DRAWINGS

FIG. 1A is an exploded view from the top of a master tool having a top surface pattern for patterned sheeting.

FIG. 1B is a back side perspective view of the master tool of FIG. 1A in a jig fixture.

FIG. 1C is a front side perspective view of the master tool of FIG. 1C.

FIG. 1D is an exploded view from the side of an alternate embodiment of the master tool.

FIG. 1E is a magnified view of a portion of FIG. 1D.

FIGS. 2A-2E are views of a slab or top plate of the master tool.

FIGS. 3A-3D are various views of a rotatable button that may be repositioned within an opening in the top plate.

FIGS. 3E-3I are perspective views of different shaped rotatable buttons and corresponding openings in the top plate that receive the rotatable buttons.

FIGS. 4A-4C illustrate various views of an aspect of a locking mechanism that may be used to hold the position of a rotatable button within the opening of the top plate.

FIGS. 5A-5B illustrate views of a subassembly of the master tool with four rotatable buttons held in position by a single retainer of the locking mechanism.

FIG. 6 is a perspective view of machine that may be used to cut a pattern into the top surfaces the master tool, including a top background or surround surface of the top plate and a top orientable surface of the rotatable buttons.

FIGS. 7A-7C are various views of a portion of a corner cube pattern that may be cut into the top surfaces of the master tool in one embodiment of the invention.

FIGS. 8A-8C are various views of a master tool to illustrate cutting a uniform pattern, such as the corner cube pattern shown in FIGS. 7A-7C, into the top surfaces of the master tool.

FIGS. 8D and 8E are various views of the master tool shown in FIGS. 8A-8C with the rotatable buttons being repositioned to a different orientation.

FIGS. 9A-9D are various views of a master tool to illustrate cutting a non-uniform pattern into the top surfaces of the master tool.

FIG. 9E is a cross sectional view of a portion of top surfaces of an alternate embodiment of the master tool.

FIGS. 10A-10C are various views of an embodiment of a master tool including a sealing sleeve around each rotatable button so as to form a sealing pattern to manufacture an integral sealing ring or structure into a patterned sheeting, such as a retro-reflective sheeting.

FIGS. 11A-11C are various views of an embodiment of a master tool including a sealing ring structure in the top surface of the top plate around each hole and the rotatable button inserted therein so as to form a sealing pattern to manufacture an integral sealing ring or structure into a patterned sheeting, such as a retro-reflective sheeting.

FIGS. 12A-12C are various views of an embodiment of a master tool including a sealing ring structure in the top surface of each rotatable button so as to form a sealing pattern to manufacture an integral sealing ring or structure into a patterned sheeting, such as a retro-reflective sheeting.

Like reference numbers and designations in the drawings indicate like elements providing similar functionality. Note that the figures are not drawn to scale so that elements, features, and surface structure may be shown by example and are intended merely to be illustrative and non-limiting of the embodiments of the invention that are claimed.

### DETAILED DESCRIPTION OF THE INVENTION

In the following detailed description of the embodiments of the invention, numerous specific details are set forth in order to provide a thorough understanding. However, it is to be understood that the embodiments of the invention may be practiced without these specific details. In other instances, known methods, procedures, elements, components, and equipment have not been described in detail so as not to unnecessarily obscure aspects of the embodiments of the invention.

Introduction

Reflectors may use an array of ball or spherical lenses formed out of an optical material to reflect incident radiation such as light. In other cases, a reflector may use an array of truncated corner cubes formed out of an optical material to reflect incident radiation. In other instances, a reflector may use an array of full corner cubes formed out of an optical material to reflect incident radiation. The operation of a corner cube retro-reflector is generally described in U.S. Pat. No. 3,817,596 (Tanaka-Jun. 18, 1974) and U.S. Pat. No. 4,349,598 (White-Sep. 14, 1982); both of which are hereby incorporated by reference.

Full corner cubes tend to be more reflectively efficient than truncated corner cubes. However, full corner cubes are more difficult to manufacture. Generally a reference to corner cubes herein is referring to truncated corner cubes. Typically, retro-reflective sheeting or film for reflectors is formed out of a thin plastic or optical material film that is transparent to desired wavelengths of electromagnetic radiation (typically the visible light spectrum). The optical material film has a base surface and a top surface. The top surface has a tiled top surface pattern transferred to it from that of a master tool. The base surface of the retro-reflective sheeting is typically a flat surface of the optical material film that receives incident light and launches the reflected light. The top surface with the tiled top surface pattern has the truncated corner cube pattern that naturally reflects incident light at pre-determined incident angles. Typical methods of manufacturing an array of truncated corner cubes into a reflective sheeting or film are by molding, stamping, or embossing processes.

The molding process typically requires one or more dies or molds which are fixed for a given pattern. A plastic, acrylic or other similar optical material in liquid or molten form, with a desired index of refraction, is poured over and into the dies or molds. The optical material requires a curing time in the dies or molds in order to take a shape which has reflective properties. Examples of molding machines and processes that may be used for manufacturing retro-reflective sheeting are generally described in U.S. Pat. No. 3,689,346 (Rowland-Sep. 5, 1972) and U.S. Pat. No. 3,811,983 (Rowland-May 21, 1974) which are both hereby incorporated by reference.

A stamping process typically requires one or more rectangular stamps or dies which have a fixed pattern are used. A soft semi-solid or semi-liquid optical material, such as plastic with a desired index of refraction, is stamped by the stamp into a shape which has reflective properties. The embossing process is somewhat similar to the stamping process but can operate in a more continuous fashion. A surface of uncured, soft semi-solid or semi-liquid optical material is embossed with the desired surface pattern by a loop of replicants (replicates), allowed to cool and cure with the desired surface pattern, and then separated from the replicants. Examples of embossing machines and processes that may be used for manufacturing retro-reflective sheeting are generally described in U.S. Pat. No. 2,849,752 (Leary-Sep. 2, 1958) and U.S. Pat. No. 4,244,683 (Rowland-Jan. 13, 1981) which are both hereby incorporated by reference.

Exemplary methods that may be used to form replicants, die, or molds of a surface of a master tool are generally described in U.S. Pat. No. 2,232,551 (Merton-Feb. 18, 1941); U.S. Pat. No. 2,464,738 (White-Mar. 15, 1949); U.S. Pat. No. 2,501,563 (Colbert-Mar. 21, 1950); U.S. Pat. No. 3,548,041 (Steding-Dec. 15, 1970); and U.S. Pat. No. 4,633,567 (Montalbano-Jan. 6, 1987); all of which are hereby incorporated by reference.

Regardless of how manufactured, various industry specifications have generated demand for visibility of retro-reflective materials that can be applied in more than one orientation. In a surface of sheeting, it is desirable to form corner cubes that use total internal reflection to reflect incident light. To meet the specification and the generated demand, it is desirable to provide tooling that can be used to manufacture retro-reflective sheeting with a surface pattern that combines areas or regions of differing corner cube orientations.

Master Tools to Form Patterned Sheeting

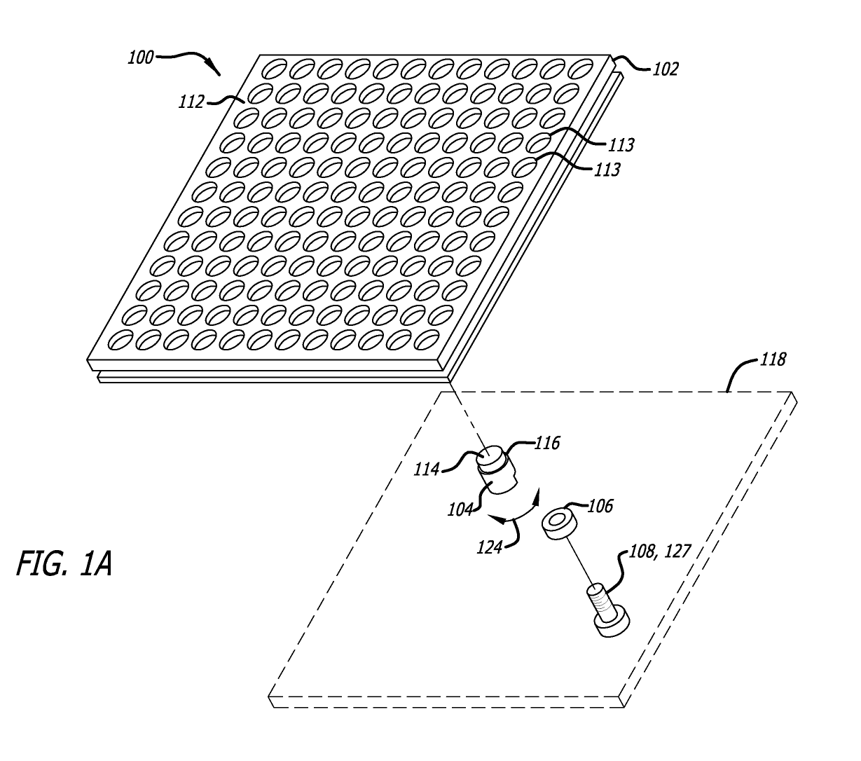

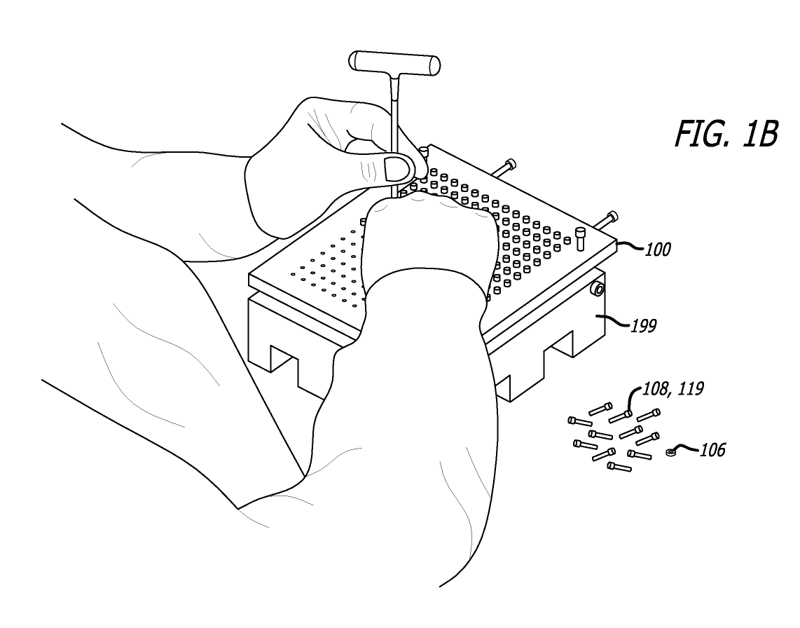

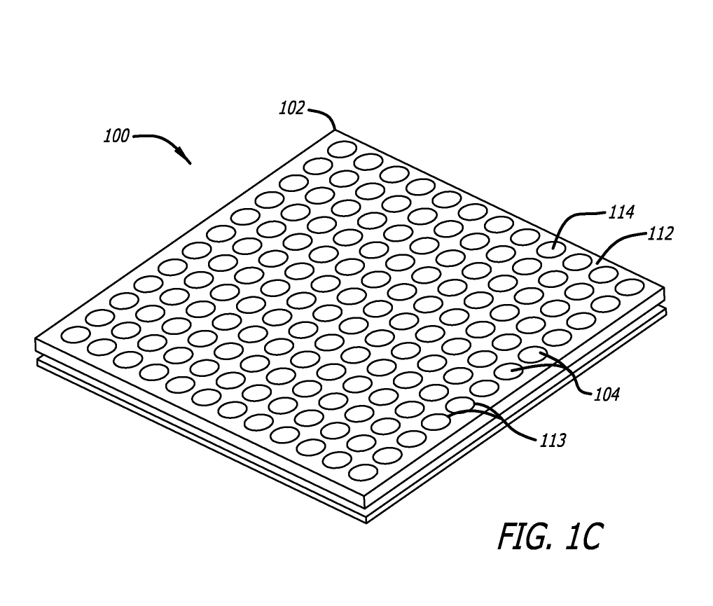

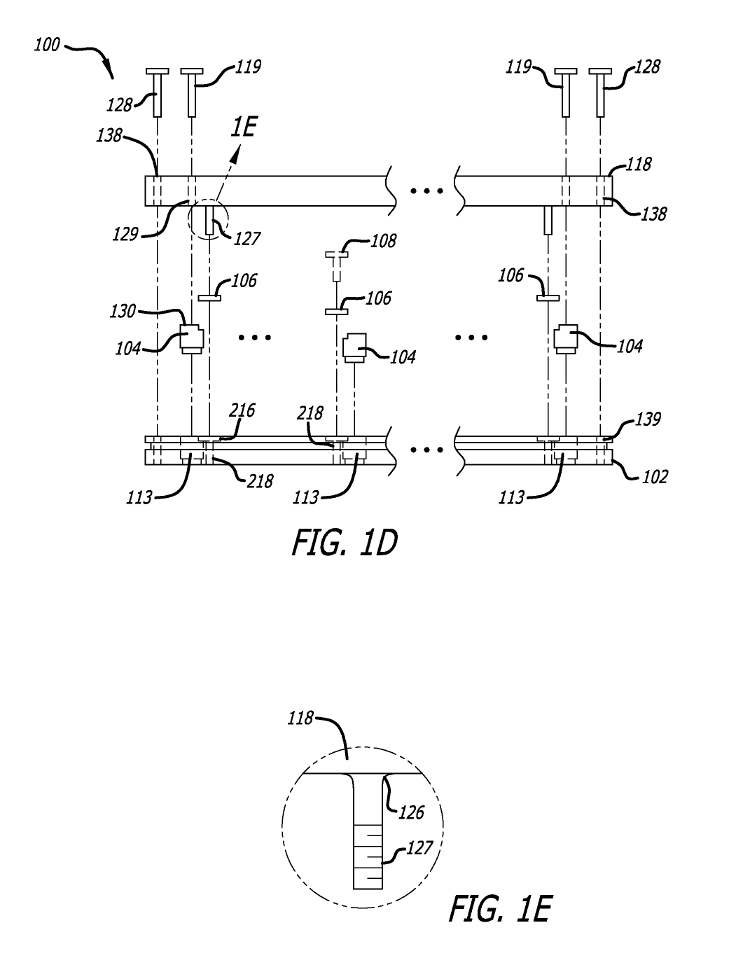

Referring now to FIG. 1A, an exploded view of a master tool 100 for manufacturing patterned sheeting, such as retro reflective sheeting, is illustrated. A pattern designed into the top surface of the master tool 100 is to be transferred into a surface during manufacture of patterned sheeting. The master tool 100 is used to form replicas, dies, or stampers having its surface pattern that are then used in the manufacture of the patterned sheeting. In this manner, the master tool 100 is used in the design of the pattern and not worn down during the repetitive molding, embossing, or stamping of the patterned sheeting.

The master tool 100 includes a slab or top plate 102 and an array of a plurality of removable or rotatable buttons 104. (For brevity, the removable or rotatable buttons 104 may be referred to as rotatable buttons or just buttons.) The slab or top plate 102 has a micromachined background patterned surface 112 and an array of a plurality of openings 113 extending from its front side to its backside. The rotatable buttons 104 include a micromachined orientable patterned surface 114 on a topside.

The top background patterned surface 112 of the top plate 102 and the top orientable patterned surface 114 of the rotatable buttons are fabricated with a metallic material, such as brass or copper, that may be micromachined to an optical finish with a diamond flycutter or scribing tool.

The master tool 100 is shown as being square with a twelve by twelve (12×12) array of round holes 113. However, it is to be understood that any other shape of plate 102 (e.g., rectangular, triangular, or oval) may be used, different shapes of holes or openings 113 (e.g., square or equilateral triangle) may be employed with different shapes of buttons 104 (e.g., square or equilateral triangle), and differing numeric of array of holes (e.g., N by M) with buttons inserted therein maybe used for forming a desired pattern in the patterned sheeting. The top surface pattern of the top plate is a single tile that may be replicated and tiled together across a surface of an optical material. The cross section shape of the top plate and the shape of the tile may be a regular polygon shape, a kite shape, or a rhombus shape so that it can be readily tiled together. For example the shape of the tile and the cross sectional shape of the top plate may be a square, an equilateral triangle, a regular pentagon, a regular hexagon, a regular octagon, a regular nonagon, or a regular decagon.

In one embodiment of the invention, the buttons 104 have a circular cylindrical shape and can be rotated within the openings 113 of the top plate 102, as indicated by the double headed arrow 124. In this case, the buttons 104 include a ringed shoulder 116 around its circular side. In another embodiment of the invention, the buttons 104 have a different geometric cylindrical shape (regular polygon cylindrical shape, e.g., square or triangular cylindrical shape) in which they can be removed from the openings 113 with a similar hollow shape, rotated to a different orientation, and replaced within the openings. The cross-section of the buttons and the openings are a regular polygon. The buttons 104 include a shoulder 116 about their sides. The buttons 104 are inserted into the openings 113 through the backside of the top plate 102. The shoulder 116 in each may meet a rest before falling out of the frontside of the top plate 102.

The master tool 100 may further include a plurality of retainer rings 106, a plurality of threaded screws 108, and an optional back plate 118 to lock or hold the buttons 104 in position within the openings 113. The buttons 104 may held in position to keep from being rotated and/or removed by a releasable locking mechanism that includes the plurality of retainer rings 106.

For every four rotatable buttons 104 inserted into the backside of the top plate 102, a retainer ring 106 may be inserted into a recess to hold the orientation of the rotatable buttons. A screw 108 may be inserted into an opening in the retainer ring 106 and threaded into openings in the backside of the plate 102 to hold their orientation, in one embodiment of the invention. In another embodiment of the invention, the back plate 118 may be positioned over the buttons 104 and the retainer rings 106 in the recesses and fastened to the top plate 102 so as to hold the orientation of the rotatable buttons. The retainers 106 and screws 108 (and optionally the back plate 118) hold a desired orientation of the rotatable buttons, keeping them from turning, when making a replica of the master tool 100. They may also be used when cutting the micromachined surfaces 112 and 114 into the rotatable buttons 104 and the top plate, respectively.

As described previously, the top surface of the top plate 102 has a micromachined surface pattern 112 that may also be referred to as a background or surround surface pattern. The top surface of the rotatable buttons 104 also have a micromachined surface pattern 114 that may be referred to as an orientable surface pattern region or a circular surface pattern region in the case of a circular cylinder button. The patterned surface 114 in the rotatable buttons 104 may be machined differently such that the background or surround patterned surface 112 in the top plate can differ from periodic patterned surfaces 114 in the master tool, regardless of the orientation of the buttons 104.

Referring now to FIG. 1B, the backside of the master tool 100 is shown fitted on top of a jig fixture 199. The master tool has the retainers 106 fitted into recesses of the top plate 102 over the buttons 104 to retain their orientation within the openings. Fasteners (e.g., screws or bolts 108, 119, 128) may be used to hold the retainers 106 in the recesses and hold the top plate and the back plate coupled together.

Referring now to FIG. 1C, a top side of the master tool 100 is illustrated. In FIG. 1C, the surfaces 112, 114 of the master tool 100 have been fully machined so that replicas may be made. A top surface of the top plate 102 has a background pattern 112 that may be a plurality of rows and/or columns of corner cubes to form a background corner cube region. Each of the rotatable buttons 104 has an orientable surface 114 that may be micromachined with a plurality of rows and/or columns of corner cubes to form a plurality of periodic circular corner cube regions of the master tool 100.

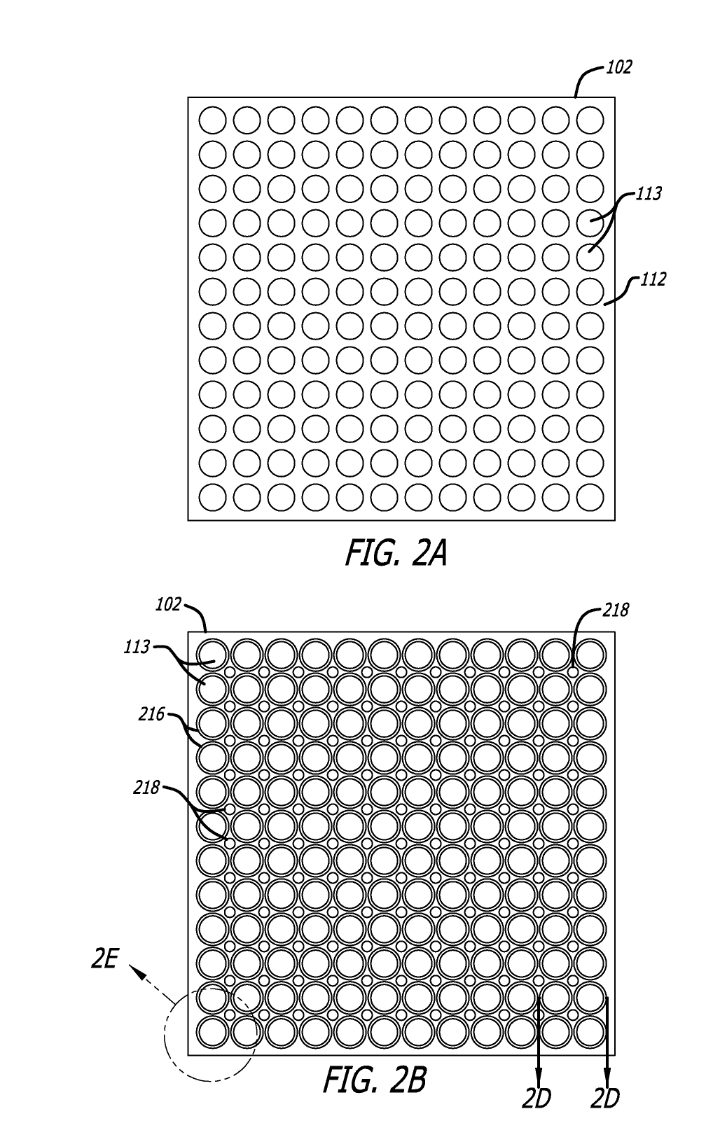

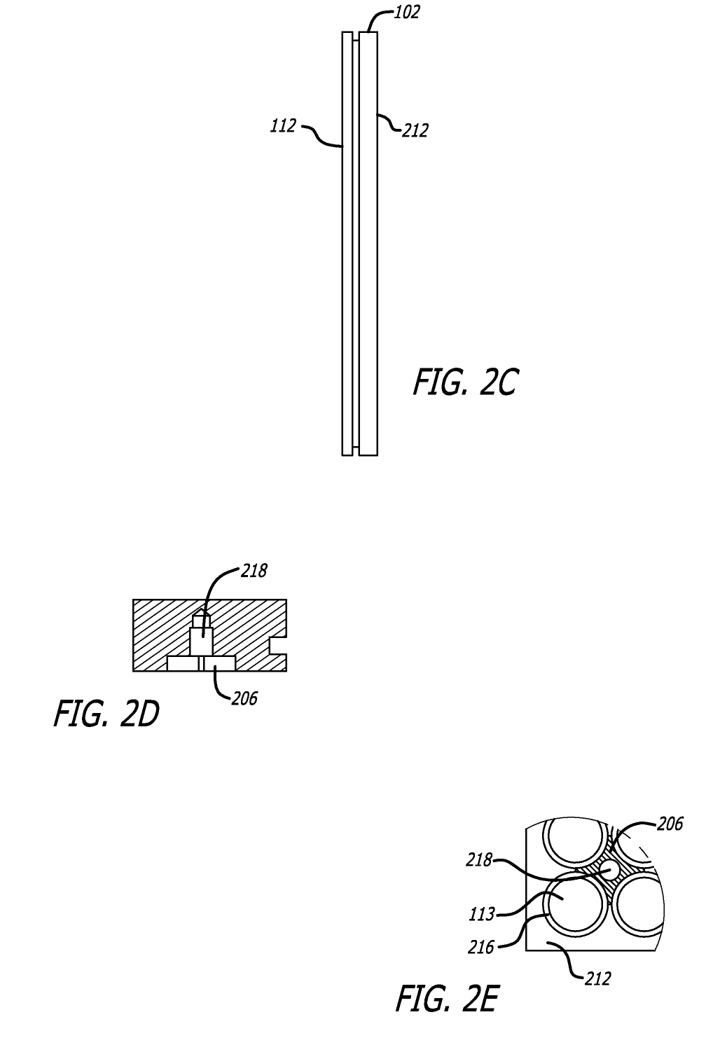

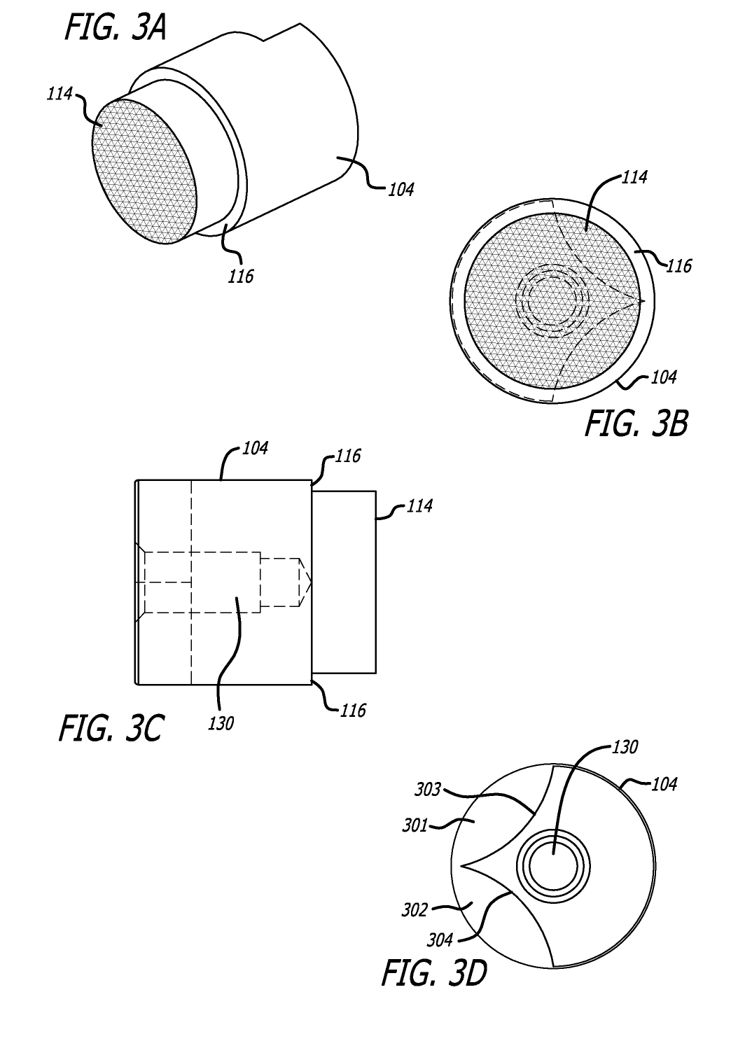

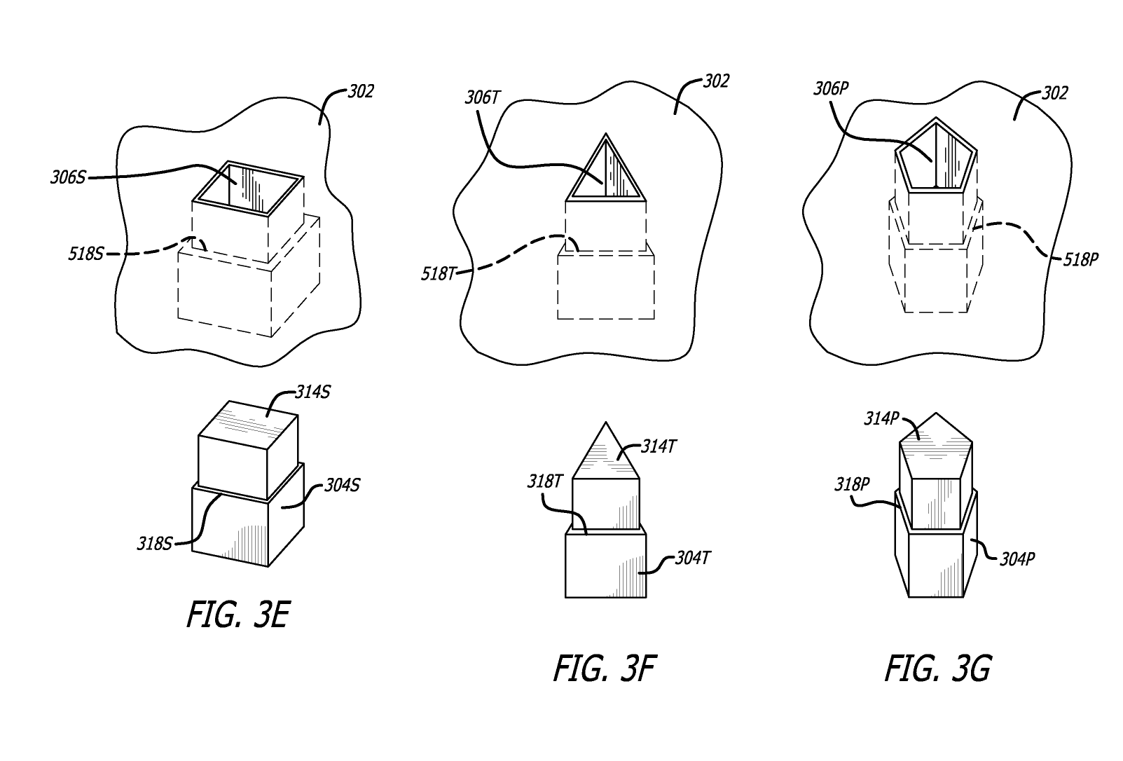

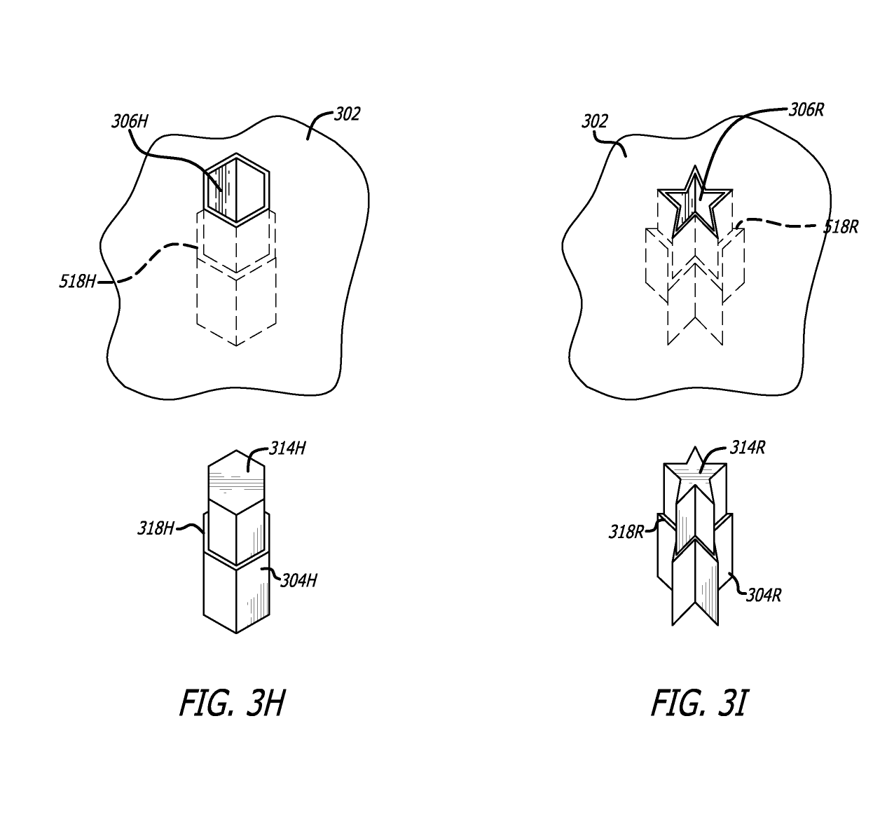

Referring now to FIG. 1D, a side exploded view of the master tool 100 with the optional back plate 118 is illustrated. The plurality of rotatable buttons 104 are inserted into the respective plurality of openings 113 in the top plate 102. The retainer rings 106 are inserted into recesses of the top plate 102 (e.g., see locking recesses 206 in FIGS. 2D and 2E) and recesses of the buttons 104 (e.g., see arched recesses 301-302 in FIG. 3D). The back plate 118 and the top plate 102 sandwiches the rotatable buttons 104 and the retainer rings 106 between them. The optional back plate 118 is coupled to the top plate 102 by one or more threaded fasteners 128 (e.g., screws or bolts) inserted through through-holes 138 and threaded into a threaded hole 139 in the back side of the top plate 102.

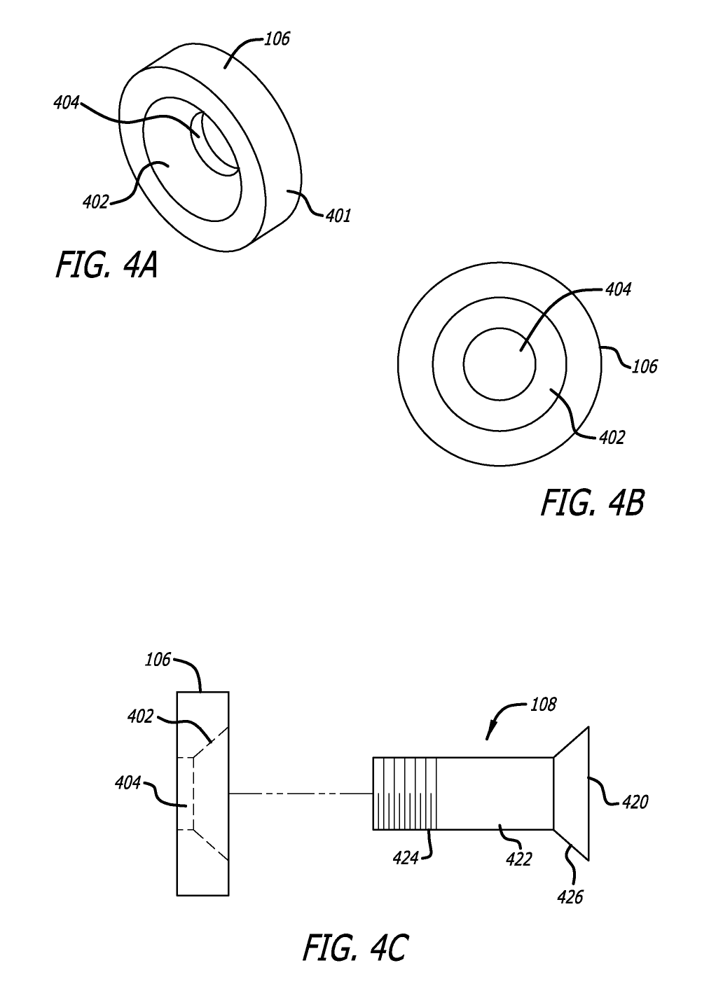

The orientation of the rotatable buttons 104 is selectively locked in place by the retainer rings 106. In one embodiment of the invention, screws 108 are inserted through an opening in the retainer rings 106 and threaded into threaded holes 218 in the top plate 102. In another embodiment of the invention, the optional back plate 118 has a plurality of retention pins 127 inserted through the opening in the retainer rings 106 and into a hole 218 in the top plate 102. FIG. 1E illustrates a magnified view of a retention pin 127 of the back plate 118. The retention pin 127 is coupled to the back plate 118 and includes a shaft that extends through an opening in the ring 106 and a tapered base 126 having a solid funnel shape to engage a funnel opening 402 (see FIG. 4C) in the ring 106.

The height of the top surface 114 of the rotatable buttons 104 may be adjustable by a height adjustment mechanism. In one embodiment of the invention, threaded screws or bolts 119 may be inserted through through-holes 129 in the back plate 118 and threaded into a threaded hole 130 in each rotatable button 104. The threaded screws or bolts 119 may be turned or rotated with the buttons locked in orientation. Turning the threaded screws or bolts 119 one way may retract the buttons 104 and another way may project the buttons 104 within the holes 113 to adjust the height of the orientable patterned surface 114 with respect to the background patterned surface 112. The adjustment of the height of the buttons may be limited in one direction by the shoulder of the buttons and a shoulder rest 216 (see FIGS. 2B and 2E) in the top plate 102. In an opposite direction, the adjustment of the height of the buttons may be limited by a distance of separation between the back side of the button and the back plate 118 or a distance of separation between the back side of the retinue ring and the back plate 118, whichever is less.

Referring now to FIGS. 2A-2E, various views of the top plate 102 are shown. FIG. 2A illustrates a front side plan view of the top plate 102, including the array of openings 113 and the top micromachined surface 112 having the background or surround pattern.

FIG. 2B illustrates a backside plan view of the top plate 102. The top plate 102 includes the plurality of openings 113 and a plurality of holes 218. The plurality of holes 218 may receive the retention pins 127 in one embodiment of the invention. In an alternate embodiment of the invention the holes 218 may have threads to receive the screws 108 or other type of fastener. Additionally, around each opening 113 is a shoulder rest 216. The shoulder rest 215 may be used to properly position the height of each rotatable button 104 and/or set a limit of height adjustment.

FIG. 2C illustrates a side view of the top plate 102 including the top side surface 112 on the top side and the back side surface 212 on the back side.

FIG. 2D illustrates a cross-sectional view of the top plate through the hole 218. As shown, the top plate 102 includes a locking recess 206 around each hole 218 to receive the retainer ring 106. The locking recess 206 is deep enough to receive the retainer ring 106. The hole 218, as described previously, may be threaded to receive the threaded screw or bolt 108. Alternatively, the hole 218 may receive the retention pin 127 of the back plate 118 instead of a threaded screw or bolt 108.

FIG. 2E illustrates a magnified view of a corner of the backside 212 of the top plate 102. FIG. 2E better illustrates the shoulder rest 216 around each opening 113 in the back side. The shoulder rest 216 is at a desired level between the top side surface and the back side surface of the top plate 102. FIG. 2E further shows a top view of the locking recess 206 around each hole 218 that is set into the back side surface 212 of the top plate 102. The perimeter of the locking recess 206 is broken by each of the four holes 218 around it.

Referring now to FIGS. 3A-3D, views of the rotatable button 104 are illustrated. FIG. 3A illustrates a perspective view of the rotatable button 104. In one embodiment of the invention, the rotatable button 104 has a circular cylindrical shape as shown. The body of the rotatable button 104 is formed of coaxial cylinders of a metal material. The top side of the rotatable button may be formed of a metal such as copper or brass so that a pattern may be cut into its face to form a patterned surface 114. If the rotatable button 104 has a circular cylindrical shape, the patterned surface 114 in the top side of the rotatable button is a circular patterned surface as shown in FIG. 3B.

As shown in FIGS. 3C-3D, the base or bottom side of the rotatable button 104 has a hole 130 and a first arched recess 301 and a second arched recess 302 cut into it. The arched recesses 301-302 have arched walls, a first position locking arched wall 303 and a second position locking arched wall 304, respectively. Additional arched recesses may be cut into the backside of the rotatable button to provide a plurality of lockable orientations. The rotatable button 104 may be locked in a plurality of positions or orientations by a retainer ring. With the retainer ring in the locking recess 206 and either arched recess 301-302, the arched walls 303-304 hold the orientation of the rotatable button 104 in a first position or a second position. The side view of the rotatable button 104 illustrated in FIG. 3C, better shows the position of the shoulder 116 below the top patterned surface 114. The shoulder 116 may couple to the shoulder rest 216 shown in FIG. 2E to limit the height of the corner cube surface 114 with respect to the surface 112 of the top plate 102.

Referring now to FIGS. 4A-4C, a circular retainer ring 106 and a threaded screw or bolt 108 are illustrated. FIG. 4A, a perspective view of the circular retainer ring 106, illustrates an outer circular ring 401 tapering down by way of a tapered funnel 402 into an opening 404 at the center of the ring. In one embodiment of the invention, the circular retainer ring 106 is made of brass. Brass, as well as other metal materials, may also be used to form the circular retainer ring 106, as well as the fasteners, and the top and bottom plates.

The thickness of the circular retainer ring 106 may be similar to the depth of the locking recess 206 shown in FIG. 2E. The depth of the arched recesses 301-302 in the buttons 104 may be greater than the thickness of the circular retainer ring 106 to allow some vertical movement of the buttons with the holes 113 under control of a threaded screw or bolt.

As shown in FIG. 4C, a side view of the circular retainer ring 106 is shown. As discussed previously, a threaded screw 108 may be insertable through the opening 404 in the ring and threaded into a threaded hole 218 shown in FIG. 2E. Alternatively, a retention pin of the back plate may extend through the opening 404. Regardless, each retainer ring 106 may lock the orientation of four adjacent rotatable buttons 104.

To lock the orientation of four adjacent rotatable buttons 104, the depth of each arched recess 301, 302 receives the thickness of the retainer ring 106. The outside circumference of the retainer meets with the locking arched wall 303 or 304 to lock the orientation of the rotatable button 104 within the hole 113.

As shown in FIG. 4C, the threaded screw or bolt 108 includes a head 420, a shaft 422, and threads 424 cut into the shaft 422. The head 420 of the screw or bolt 108 has a tapered base 426 to interface or mate with the tapered funnel opening 402 in the retainer ring 106. The tapering interface may ensure that the retainer ring remains in position about the threaded screw or bolt so that there is little side movement and change in orientation when the rotatable buttons 104 are locked.

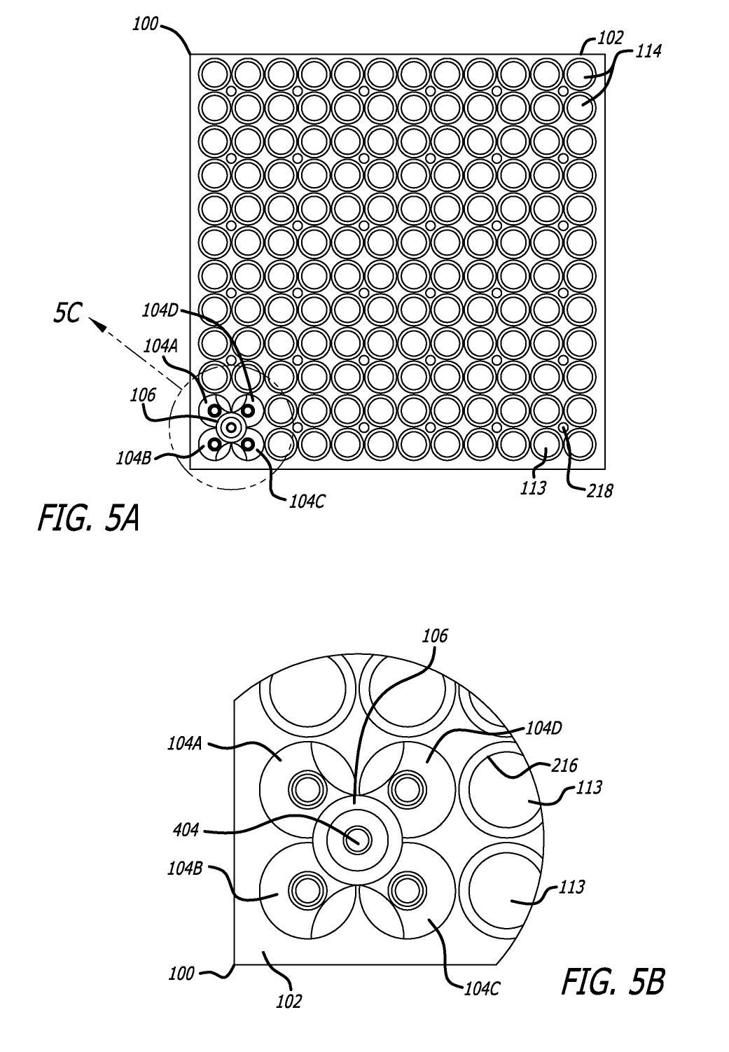

Referring now the Figures of 5A-5B, back side views of a sub-assembled master tool 100 are shown. In FIGS. 5A-5B, four rotatable buttons 104A-104D are positioned within four openings 113 of the top plate 102 around a hole 218. A retainer ring 104 is inserted into the locking recess 206 of the top plate 102 and engaged an arched recess 301 or 302 of each rotatable button 104A-104D. The shoulder 116 of each rotatable button 104A-104D may be directly or indirectly coupled to the shoulder rest 216 within each hole 113.

With the circular retainer ring 106 engaged in the recesses 301 of 302 of each rotatable button 104A-104D, the threaded screw 108 may be inserted within the opening 404 to lock the retainer ring into the recess and the orientation of the rotatable buttons 104A-104D. Alternatively, after all the rotatable buttons 104 have been inserted into the openings 113 and all retainer rings 106 are engaged into the recesses 206, 301 or 302; retention pins may be inserted into the openings of the retainer rings and the back plate coupled to the top plate to lock the retainer ring into the recesses and the orientation of the rotatable buttons within the openings.

With each rotatable button 104 inserted into each respective opening 113 with its orientation locked in placed by the retainer rings 106 and the screws 108 and/or back plate 118, the respective patterns 112,114 in the top surfaces of the top plate 102 and each of the rotatable buttons 104 may be cut.

Master Tool with Non-Circular Buttons

Circular rotatable buttons in circular holes provide for a wide range of angles R₁-R_{N} over which they may be rotated. If fewer angles can be supported, the rotatable buttons and the holes in which they are inserted may take on different geometric shapes.

Referring now to FIGS. 3E-3I, rotatable buttons with different cylindrical shapes are shown that may be fitted into holes of the same cylindrical shape. Each rotatable button has a larger base cylindrical shape than a top cylindrical shape in order to form a shoulder. Similarly, each hole has a larger hollow base cylindrical shape than that of the hollow top cylindrical shape to form a shoulder. A top surface of the top cylindrical shape of each button includes the orientable patterned surface with an area having the shape of the cross section of the top cylindrical shape.

FIG. 3E illustrates a square rotatable button 304S with a square orientable patterned surface 314S and a square cylindrical body. Square rotatable buttons 304S fit into square holes 306S and can be re-oriented by ninety (90) degree increments of 90, 180, and 270 degrees. The square rotatable button 304S has a square shaped shoulder 318S that may come to rest against a square shaped rest or stop 518S in the square cylindrical shaped hole 306S.

FIG. 3F illustrates a triangular rotatable button 304T with a triangle orientable patterned surface 314T and a triangle cylindrical body. Triangular rotatable buttons 304T fit into triangle cylindrical holes 306T and can be re-oriented by one-hundred-twenty (120) degree increments of 120 and 240 degrees. The triangular rotatable button 304T has a triangular shaped shoulder 318T that may come to rest against a triangular shaped rest or stop 518T in the triangle cylindrical shaped hole 306T.

FIG. 3G illustrates a pentagonal rotatable button 304P with a pentagon orientable patterned surface 314P and a pentagon cylindrical body. Pentagonal rotatable buttons 304P fit into pentagonal cylindrical holes 306P and can be re-oriented by seventy-two (72) degree increments of 72, 144, 216, and 288 degrees. The pentagonal rotatable button 304P has a pentagonal shaped shoulder 318P that may come to rest against a pentagonal shaped rest or stop 518P in the pentagon cylindrical shaped hole 306P.

FIG. 3H illustrates a hexagonal rotatable button 304H with a hexagon orientable patterned surface 314H and a hexagon cylindrical body. Hexagonal rotatable buttons 304H fit into hexagonal cylindrical holes 306H and can be re-oriented by sixty (60) degree increments of 60, 120, 180, 240, and 300 degrees. The hexagonal rotatable button 304H has a hexagonal shaped shoulder 318H that may come to rest against a hexagonal shaped rest or stop 518H in the hexagon cylindrical shaped hole 306H.

FIG. 3I illustrates a star rotatable button 304R with a star orientable patterned surface 314R and a star cylindrical body. Star rotatable buttons 304R fit into star cylindrical holes 306R. If five sided as shown, a star rotatable button can be re-oriented by seventy-two (72) degree increments of 72, 144, 216, and 288 degrees. If the triangle shape is N-sided, a star rotatable button can be re-oriented by increments of N/360 degrees. The star rotatable button 304R has a star shaped shoulder 318R that may come to rest against a star shaped rest or stop 518R in the star cylindrical shaped hole 306R.

Generally, a rotatable button may be shaped to any other geometric cylindrical shape having equilateral sides to fit in openings having the same geometric cylindrical shape but hollow with equilateral sides.

Top Surface Pattern Formation in a Master Tool

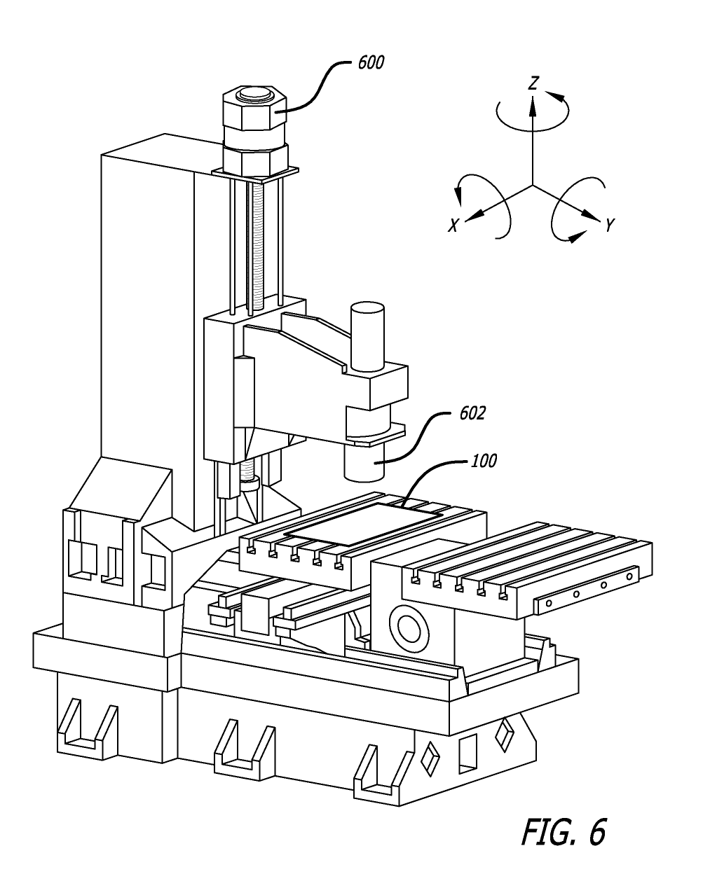

Referring now to FIG. 6, an exemplary computerized numeric cutting (CNC) machine 600 is shown with six degrees of freedom to cut a pattern into the top surface of the master tool 100 including the respective patterns 112,114 in the top surfaces of the top plate 102 and each of the rotatable buttons 104. The exemplary CNC machine 600 includes a diamond cutting head 602 that can cut the desired pattern into the top surfaces of the master tool 100. With six degrees of freedom, the CNC machine 600 and its diamond cutting head 602 may cut a large number of patterns into the top surface of the master tool 100. In one embodiment of the invention, a corner cube pattern is cut into the top surfaces (surface 112 of the top plate 102 and orientable surface 114 of each of the rotatable buttons 104) of the master tool 100.

Generally, a pattern of corner cubes, prisms, pyramids, or other surface treatment pattern is formed in the surface of the master metal plate or other suitable material by scribing, cutting, or micro-machining Corner cubes and other similar retro-reflector designs are formed in the surface of the master metal plate by means of a direct ruling technique with a v-shaped diamond tool having two edges of the cutting face ground and polished on a diamond-charged lap so that the metal surfaces are optically flat and manifest specular reflectance with high efficiency. The v-shaped diamond tool cuts three sets of V-shaped grooves.

By ruling the grooves in fairly soft metal, e.g., aluminum or copper, which has been polished flat on one surface without causing the surface to be charged up with abrasive, capable of accentuating the wear of the diamond, the diamond tool imparts an optical polish to the walls of the grooves (faces of the pyramids), leaves the tips of the pyramids sharp, and does not leave burrs or rough edges at the intersections of the faces of the pyramids with one another. If a single diamond tool is used in a shaper-type ruling engine (one in which the tool is constrained to travel in a straight line, cutting on the forward stroke, lifted on the return stroke, with the work being translated at right angles thereto by pre-selected increments after the end of each cutting stroke), each groove requires as few as five and as many as ten passes to obtain the desired depth. At this point, the die is finished, and no additional polishing of the faces of the pyramids is required. However, because the metal is soft, such a master die is usually not used to directly emboss a pattern into a sheeting. Thus, a suitable replication procedure is followed in order to obtain dies capable of producing corner cube cavities and corner cube prisms.

The top background patterned surface 112 of the top plate 102 and the top orientable patterned surface 114 of the rotatable buttons 104 may be arranged to be in the same plane and cut coincidentally as a single pattern across a top surface of the top plate.

Alternatively, the top background patterned surface 112 of the top plate 102 and the top orientable patterned surface 114 of the rotatable buttons 104 may be arranged to be in different planes and cut separately with different patterns.

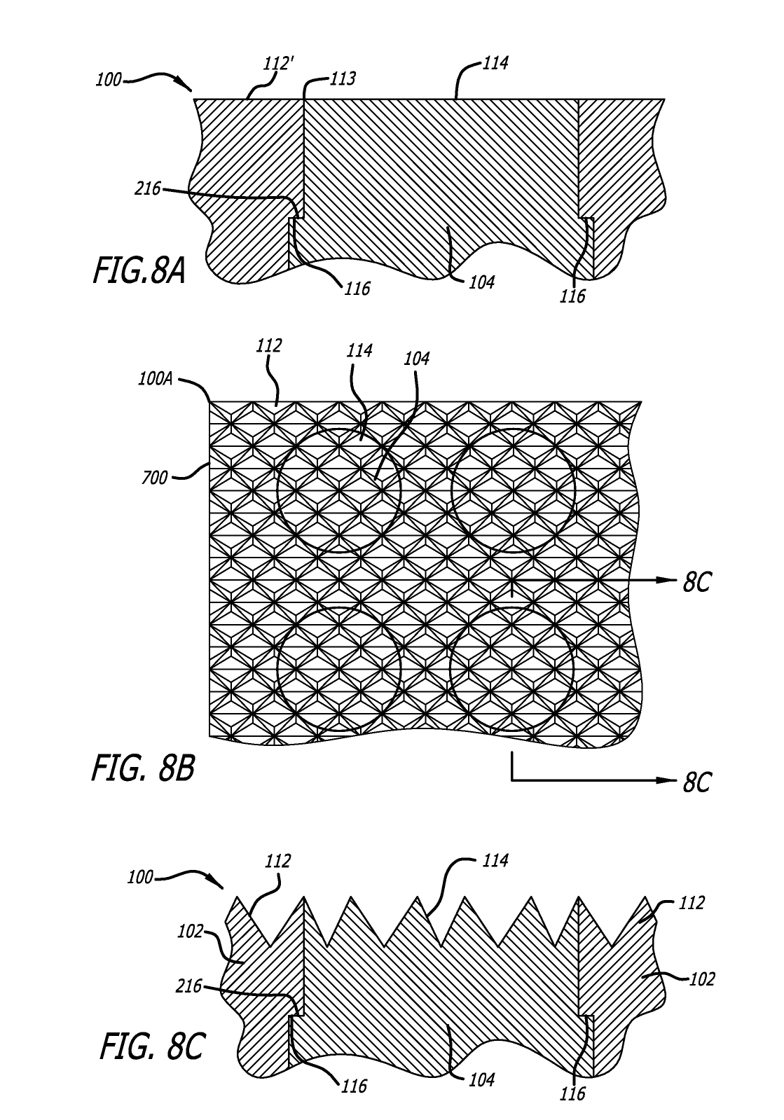

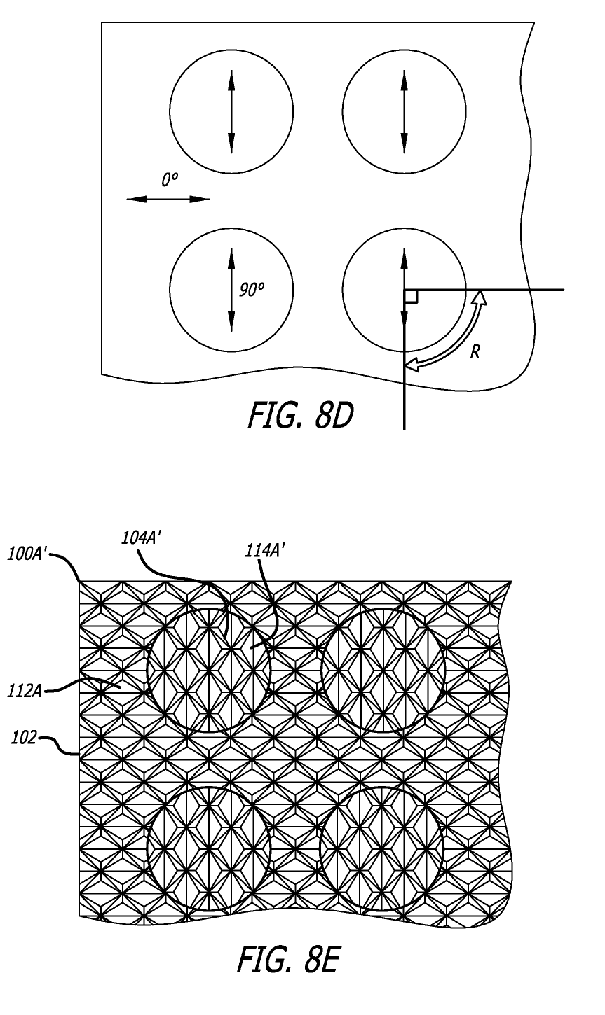

Referring momentarily now to FIG. 8A, a cross sectional view of the master tool 100 is shown without any of the top surface of the master tool 100 (background surface 112 of the top plate and orientable surfaces 114 of the rotatable buttons 104) being cut. Each of the rotatable buttons 104 are locked in place within the openings 113 as shown. The shoulder 116 of the rotatable button 104 may be brought up against the shoulder rest 216 in the hole 113. Initially, the top surfaces of the master tool 100 (background surface 112′ of the top plate and orientable surfaces 114′ of the rotatable buttons 104) are smooth and flat. The uncut top orientable surfaces 114′ of the rotatable buttons 104 are arranged to be substantially level (e.g., in the same plane) with the uncut background surface 112′ of the top plate 102. The CNC machine 600 is then used to cut a pattern into the top surfaces of the master tool 100. For example, the CNC machine 600 may be used to cut three V shaped grooves to form a uniform corner cube pattern across the top surfaces of the master tool 100.

To form corner cubes, three series of V-shaped grooves angled apart from each other (e.g., sixty degrees apart) are inscribed into the surface of the master metal plate. The V-shape that is inscribed into the surface may change from groove to groove to change the angles of the facets to cant the corner cube off of a perpendicular optical axis. Furthermore, the tops of the corner cubes may be lopped off such as by milling to provide a different retro-reflective structure in one embodiment of the invention.

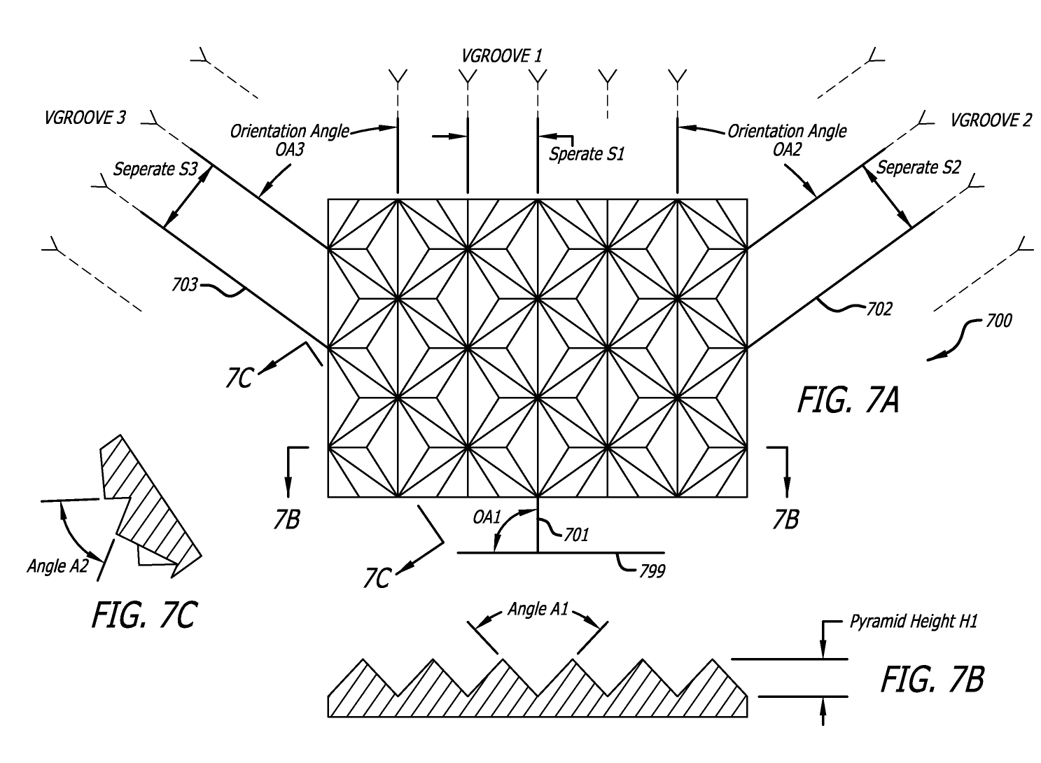

Referring now to FIGS. 7A-7C, views of a portion of an exemplary corner cube pattern 700 is illustrated. The exemplary corner cube pattern 700 may be a first pattern that is cut into top surfaces of the master tool 100. For a uniform first pattern, the exemplary corner cube pattern 700 may cut across all top surfaces of the master tool 100, including the background surface 112 of the top plate 102 and the top surface 114 of each rotatable button 104.

To form a pattern of retro-reflectors in the master tool for manufacture of a surface of sheeting, three V shaped grooves are machined in three different directions to form corner cubes with three facets that may be oriented approximately orthogonal to each other. The optical axis (or symmetry axis between the corner cube faces) may be canted or tilted away from an orthogonal axis to a surface of the sheeting in order to achieve wider angularity in any defined viewing plane.

FIG. 7A illustrates a top view of an exemplary corner cube pattern that the diamond cutting head 602 can cut into the top surface of the master tool 100. A first V shaped groove, a second V shaped groove, and a third V shaped groove may each have a differing V shape formed by the different cuts made by the diamond cutting head.

With two passes of the diamond cutting head along each parallel primary groove line 701, a first set of parallel V shaped grooves Vgroove1 may be cut vertically over the top surface of the master tool 100. The parallel primary groove lines 701 are oriented at a first orientation angle OA1 with an edge 799 of the master tool. In one embodiment of the invention, the parallel primary groove lines 701 are perpendicular to the edge 799 of the master tool 100 so that the first orientation angle OA1 is ninety (90) degrees. The V shape cut into the surface is may be perpendicular to the parallel primary groove lines 701. Each of V shaped grooves of the first set of parallel V shaped grooves Vgroove1 runs parallel along their respective primary groove line 701. Each of the primary groove lines 701 are separated from each other by a first separation distance S1.

FIG. 7B illustrates a first cross section of the corner cube pattern 700 across (perpendicular to) the parallel primary groove lines 701 of the exemplary corner cube pattern of FIG. 7A. FIG. 7B shows a side view of the first V shaped groove of the first set of parallel V shaped grooves Vgroove1 that may be cut into the surface of the master tool 100. The two passes of the cutting head cut at angles with a perpendicular axis to the top surface form a first angle A1 between first facets of the corner cubes forming the first V shaped groove. The depth and angles of the cuts into the surface along the parallel primary groove lines 701 generally form the pyramid height H1 of the first facets.

After cutting the first set of parallel V shaped grooves Vgroove1, the diamond cutting head 602 is oriented to a second orientation angle with respect to the primary groove lines 701. With two passes, the diamond cutting head may then a cut a second set of parallel V shaped grooves Vgroove2 along parallel secondary groove lines 702 oriented at the second orientation angle OA2 with the parallel primary groove lines 701. Each of the second groove lines 702 are separated from each other by a second separation distance S2.

FIG. 7C illustrates a second cross section of the corner cube pattern 700 across (perpendicular to) the secondary groove lines 702 of the exemplary corner cube pattern of FIG. 7A. FIG. 7C shows a side view of the second V shaped groove of the second set of parallel V shaped grooves Vgroove2 that may be cut into the surface of the master tool 100. The two passes of the cutting head cut at angles with a perpendicular axis to the top surface form a second angle A2 between second facets of the corner cubes forming the second V shaped groove. The depth and angles of the cuts into the surface along the parallel secondary grooves 702 generally form the pyramid height H2 of the second facets.

After cutting the second set of parallel V shaped grooves Vgroove2, the diamond cutting head 602 is oriented to a third orientation angle OA3 with respect to the primary groove lines 701. The diamond cutting head 602 may then cut a third set of parallel V shaped grooves Vgroove3 along parallel veterinary groove lines 703 oriented at the third orientation angle OA3 with the parallel primary groove lines 701. The veterinary groove lines 703 may be oriented at an angle with the secondary groove lines 702 in the amount of the sum of the second orientation angle OA2 and the third orientation angle OA3. Each of the veterinary groove lines 703 are separated from each other by a third separation distance S3.

The cross section illustrated by FIG. 7C may also be exemplary of the cross section across the veterinary groove lines 703 of the exemplary corner cube pattern of FIG. 7A but with possibly a different angle and different depths and heights of corner cubes to form third facets of the corner cubes forming the third V shaped groove. In one embodiment, the third V shaped groove is the same as the second V shaped groove.

The two passes of the cutting head to form each of the third set of parallel V shaped grooves Vgoove3 cut at angles with a perpendicular axis to the top surface form a third angle A3 between third facets of the corner cubes forming the third V shaped groove. The depth and angles of the cuts into the surface along the parallel tertiary groove lines 703 generally form the pyramid height H3 of the third facets.

Additional V-shaped grooves, different shaped grooves, different cut angles, different orientation angles, different cutting depths, pattern tiling, and other known patterning techniques to obtain different types of corner cube pattern designs may be used and cut into the surfaces of the top plate and buttons. Further information regarding different exemplary designs of corner cube patterns for the top patterned surfaces of the master tool are described in U.S. Pat. No. 3,057,256 (Erban-Oct. 6, 1962); U.S. Pat. No. 3,712,706 (Stamm-Jan. 23, 1973); U.S. Pat. No. 4,189,209 (Heasley-Feb. 19, 1980); U.S. Pat. No. 4,202,600 (Burke-May 13, 1980); U.S. Pat. No. 4,243,618 (Van Arnam-Jan. 6, 1981); U.S. Pat. No. 4,588,258 (Hoopman May 13, 1986); U.S. Pat. No. 4,938,563 (Nelson-Jul. 3, 1990); U.S. Pat. No. 5,564,870 (Benson-Oct. 15, 1996); U.S. Pat. No. 5,565,151 (Nilsen-Oct. 15, 1996); U.S. Pat. No. 5,706,132 (Nestegard-Jan. 6, 1998); U.S. Pat. No. 5,764,413 (Smith-Jun. 9, 1998); U.S. Pat. No. 5,831,767 (Benson-Nov. 3, 1998); U.S. Pat. No. 5,936,770 (Nestegard-Aug. 10, 1999); U.S. Pat. No. 6,168,275 (Benson-Jan. 2, 2001); U.S. Pat. No. 6,258,443 (Nilsen-Jul. 10, 2001); U.S. Pat. No. 6,457,835 (Nilsen-Oct. 1, 2002); U.S. Pat. No. 6,533,887 (Smith-Mar. 18, 2003); and U.S. patent application Ser. No. 08/139,462 (Benson-Oct. 20, 1994) published as International Publication No. WO 95/11465 on Apr. 27, 1995; all of which are hereby incorporated by reference.

Referring momentarily now to FIG. 8B, a portion of the top surface of the master tool 100A is illustrated with the exemplary surface pattern 700 uniformly cut into the background patterned surface 112 and the orientable patterned surface 114 in the rotatable buttons 104. Each of the rotatable buttons 104 remain locked in their initial orientation within the openings 113.

Referring now to FIG. 8C, a cross section of the master tool 100A is illustrated to show the uniform pattern cut across the top surface 112 of the top plate 102 and the orientable patterned surface 114 of the rotatable buttons 104. In FIG. 8C, the buttons 104 remain oriented within the holes 113 as the top orientable patterned surface 114 and the top background surface 112 of the top plate were cut.

After the top surfaces are cut to form the orientable pattern 114 in each button 104 and the background pattern 112 in the top plate 102, the rotatable buttons may be unlocked by unscrewing the screws 108 or decoupling the back plate from the top plate so that the retainer rings may be disengaged from the recesses 206 and 301 or 302. With the buttons unlocked, they may be rotated so that the orientable pattern 114 is in a different position in comparison to the orientation of the background pattern 112. A different overall pattern is formed in the top side of the master tool with a periodic oriented patterned surface 114 having a different orientation due to the rotatable buttons 104. For example, the rotatable buttons 104A-104D may be rotated to a locked position within the second arched recess 302, such each button may be rotated by an angle of eighty-eight (88) degrees from its initial locked position within the first arched recess 301. Further arched recesses may be cut into the back side of each button 104, other than arched recesses 301-302, so that different angles of orientation may by provided to provide yet another differing overall pattern in the top side surface of the master tool 100.

Referring now to FIG. 8D, the rotatable buttons 104 are unlocked. Some or all of the rotatable buttons 104 may then be rotated or positioned at a different orientation so that the top orientable patterned surface 114 is oriented differently than the orientation of the background patterned surface 112. For example, each of the buttons may be rotated by the angle R, such as by ninety (90) degrees for example to design a retro-reflective sheeting with wide angularity in multiple viewing planes. The primary groove lines 701 in the orientable patterned surface 114 are at an angle R with the primary groove lines 701 in the background patterned surface 112. With the angle R being ninety degrees, the primary groove lines 701 in the orientable patterned surface 114 are perpendicular with the primary groove lines 701 in the background patterned surface 112. After rotating or repositioning the buttons, the buttons may locked in orientation within the holes of the top plate once again by the retaining rings 106.

FIG. 8E illustrates a top view of a portion of the master tool 100A′ after the rotatable buttons 104 have been rotated as shown in FIG. 8D. The buttons in their rotated position are now referenced as rotatable buttons 104A′. As can be seen in FIG. 8E, the master tool 108′ has a background patterned surface 112 in its top side, while the rotated buttons 104A′ have an orientable top pattern surface 114A′ with a different orientation. The circular region of corner cubes 114A′ in the top surface of each rotatable button 104A′ is now oriented in a different direction (e.g., perpendicular or orthogonal) in comparison with the orientation of the corner cubes 112A in background patterned surface 112A of the top plate 102.

With the buttons 104A′ locked in orientation, the top surface of the master tool 100A′ may be used to make replicas.

If the master tool 100A is used to form retro-reflective sheeting, a first angularity and a first retro-reflective performance is provided for incident light. If the master tool 100A′ is used to form retro-reflective sheeting, a second angularity and a second retro-reflective performance is provided for incident light differing from the first angularity and the first retro-reflective performance. By simply rotating the circular corner cube regions 114A of the rotatable buttons 104A with respect to the backgrounder patterned region 112 of the top plate 102, different retro-reflective sheeting can be manufactured.

Master Tool with Different Periodic Patterns

As shown previously, the same pattern may be cut into the background surface 112 in the top surface 114 of each of the rotatable buttons 104, so there is a uniform pattern. Alternatively, the background patterned surface 112 of the top plate 102 may be cut separately from the top orientable patterned surface 114 in each of the rotatable buttons 104.

Furthermore, the rotatable buttons may have different patterns from each or may be grouped in the different sets of patterns. Instead of the CNC machine 600 cutting the top surface 112 of the top plate 102 and the top surfaces 114 of the rotatable buttons 104 together, they may be cut separately with different types of patterns. For example, the top surface 112 of the top plate 102 may be cut with a first pattern while the top surfaces 114 of the rotatable buttons 104 are cut with a second pattern differing from the first pattern or with other patterns differing from each of the other patterns.

The rotatable buttons 104 may be removed or lowered beneath the surface 112 of the surrounding top plate 102 to allow cutting of the first pattern only into the surface 112. The rotatable buttons 104 may then be raised above the patterned surface 112 of the top plate 102 to allow cutting of a second pattern with a different orientation or different canting direction in the peaks of the corner cubes into the surface 114 of the rotatable pins 104.

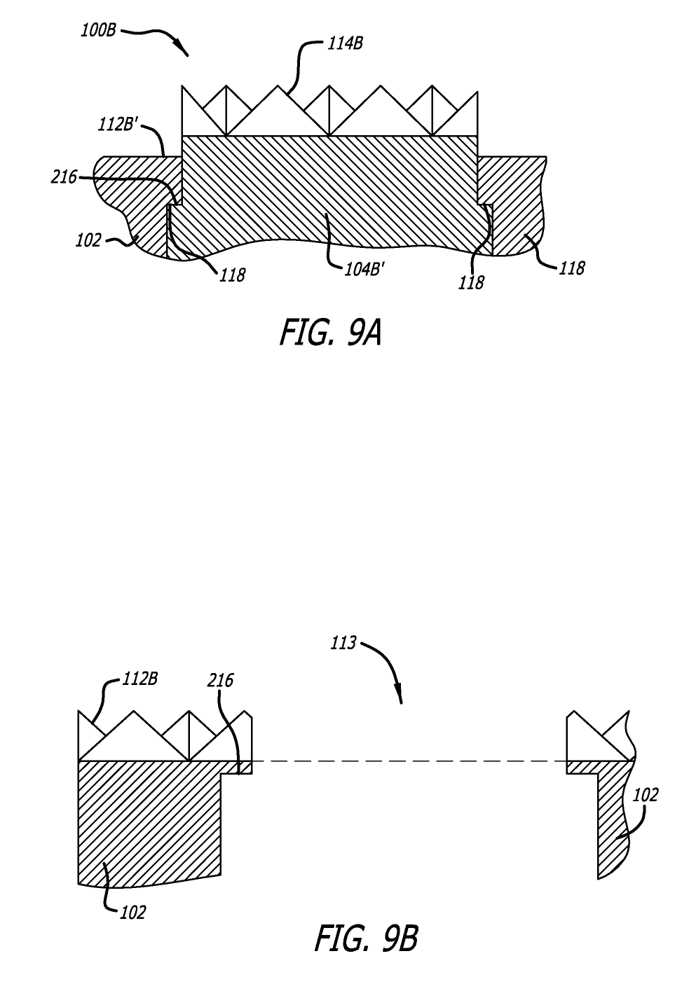

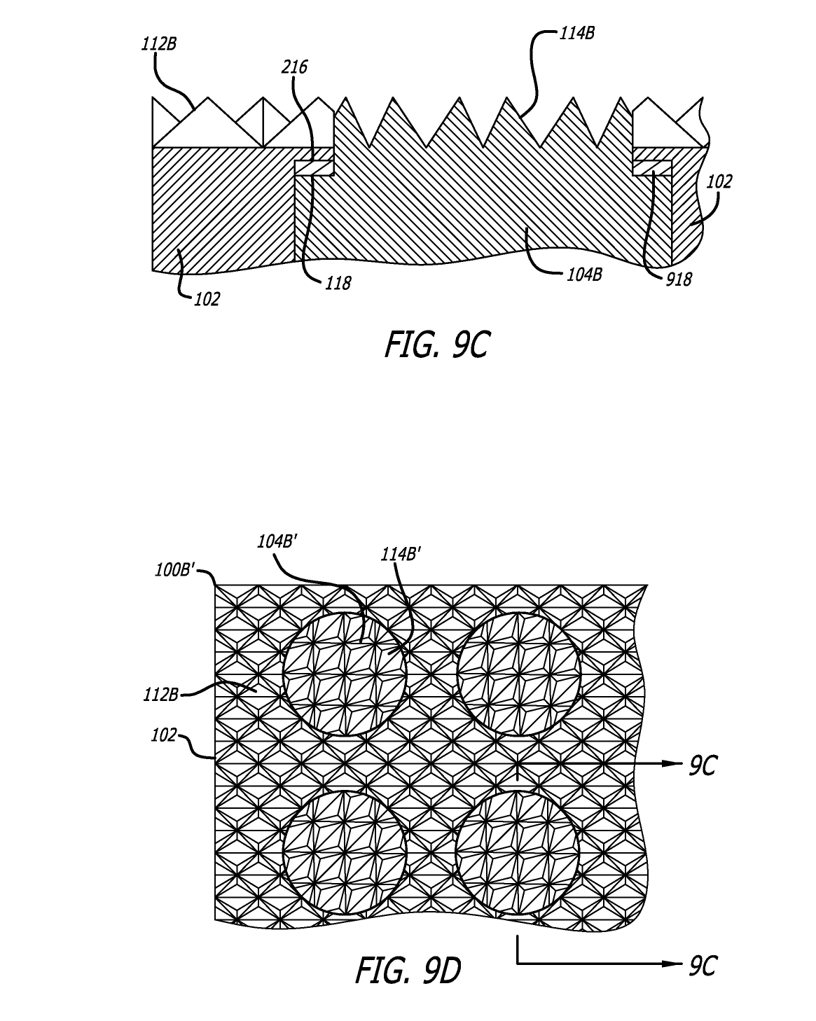

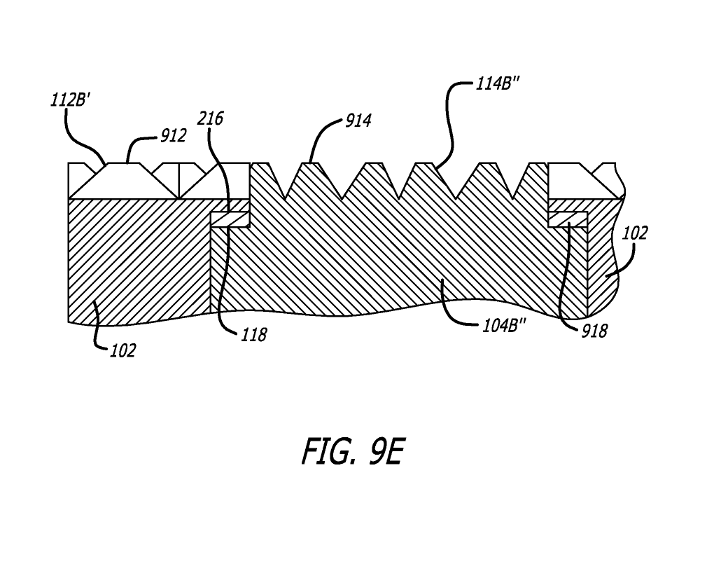

Referring now to FIGS. 9A-9D, an exemplary method of cutting different patterns into the background surface 112 of the top plate 102 and the top surface 114 of the rotatable buttons 104 is now described. In this case, the buttons 104B may have a slightly different geometry, such that the uncut height of their top surfaces 114′ may extend above the uncut height of the top surface 112′ of the top plate shown in FIG. 8A. The uncut top surfaces 114′ of the buttons 104 may be cut with a first pattern while the uncut top surface 112′ of the top plate 102 may be cut with a second pattern differing from the first pattern.

FIG. 9A illustrates a cross section of a first pattern cut into top surface of a button to form an orientable patterned surface 114B in the rotatable button 104B. With the shoulders 118 resting up against the shoulder rest 216, the orientable patterned surface 114B of the master tool 100B extends above the uncut background surface 112B′. This extension allows the top surface of the buttons 104B to be cut with a first pattern without cutting the background surface.

Referring now to FIG. 9B, the rotatable buttons 104B may be removed from the openings 113 or adjusted to be below the top surface of the top plate 102 with a threaded screw or bolt. The top surface of the top plate may be cut with a second pattern differing from the first pattern to form the background patterned surface 112B in the top plate 102. In this manner, the pattern of the background patterned surface 112B of the top plate 102 differs from the pattern cut into the orientable patterned surface 114B of the rotatable buttons 104B.

The difference in patterns is not just a change in orientation made possible by the rotatable buttons but a change in the pattern that is being cut. Without any rotation of the rotatable buttons 104B, a different periodic orientable pattern surface area 114B′ is periodically present within the top surface of the master tool 100B. Furthermore, the rotatable buttons 104B may still be rotated or re-oriented so that another differing overall pattern may be formed within pattern sheeting during its manufacture using the top surface pattern design of the master tool 100B.

Referring now to FIG. 9C, the rotatable buttons 104B are returned into the openings 113 in the top plate 102. To adjust the heights of the first pattern 114B in the rotatable buttons 104B with that of the surface pattern 112B in the top plate 102, a height equaling mechanism may be utilized. In one embodiment of the invention, a height equalizing or spacer ring 918 may be employed to space the shoulder 118 of the button 104B away from the shoulder rest 216 in the top plate 102. With the spacer ring 918 placed over each of the buttons 104, the buttons can be inserted back into the openings 113 so that the height of the orientable patterned surface 114B of the rotatable buttons 104B is substantially equal to the height of the background patterned surface 112B in the top plate 102 such as shown in FIG. 9C. Alternatively, the height of surface 114B of the rotatable buttons 104B within the openings 113 may be adjusted with a threaded screw or bolt to be substantially equal to the height of the background patterned surface 112B in the top plate 102.

The rotatable buttons 104B may still be rotated so that a different overall pattern may be formed within pattern sheeting during its manufacture using the top surface pattern design of the master tool.

Referring now to FIG. 9D, the rotatable buttons 104B′ have been unlocked; rotated, re-oriented or repositioned to a different orientation; and re-locked so that the top orientable patterned surface 114B′ in each button 104B′ is oriented differently than the orientation of the background patterned surface 112B. With the buttons 104B′ locked in their new orientation, the top surface of the master tool 100B′ may be used to make replicas.

Referring now to FIG. 9E, peaks of corner cubes may be cut, milled or machined off such that the corner cubes have a flat top in another embodiment of the invention. In FIG. 9E, the background patterned surface 112B′ of the top plate 102 has flat triangular shaped tops 912 as the peaks of its corner cubes were machined off. The orientable patterned surface 114B″ of the button 104B″ has flat triangular shaped tops 914 as the peaks of its corner cubes were machined off. Retro-reflective sheeting manufactured with flat topped corner cubes from a top surface pattern design of a master tool with the same may have an improved efficiency in retro-reflection of incident light of a given incident angle.

Master Tool with Seal Forming Mechanism

In yet another embodiment of the invention, it may be desirable to form a seal around the periodic orientable patterns that are manufactured into the sheeting. A sealing ring may be formed around circular orientable patterns and sealing walls may be formed around square orientable patterns, triangular orientable patterns, or other geometric orientable patterns.

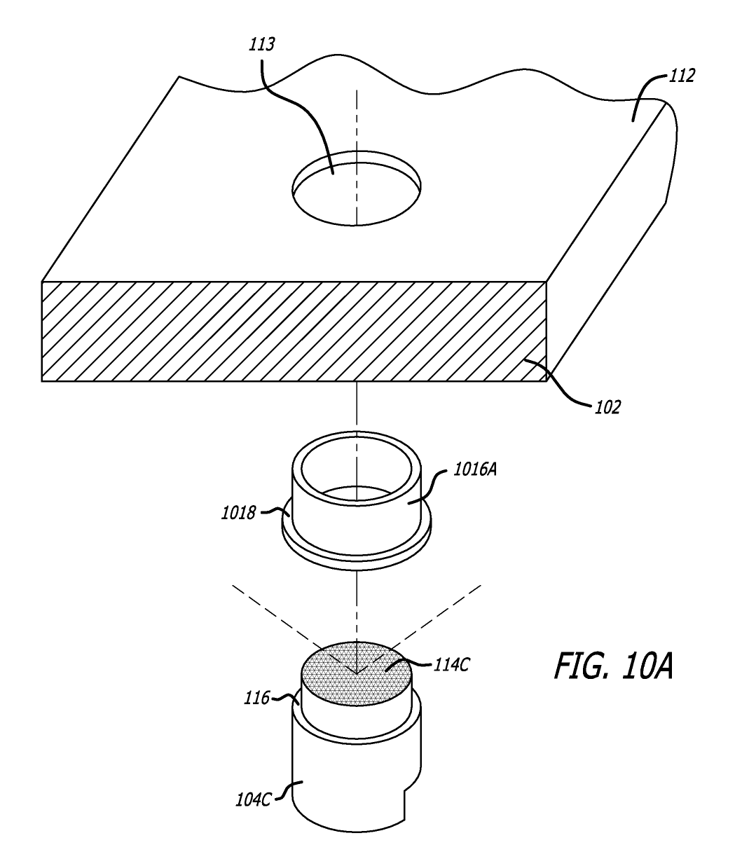

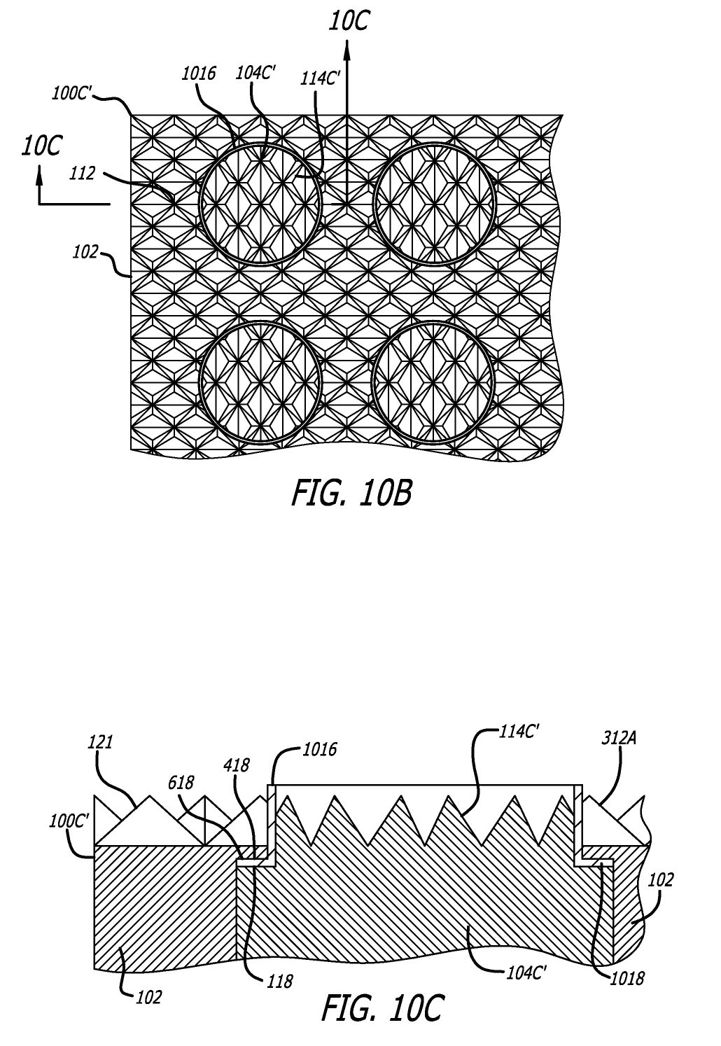

Referring now to FIG. 10A, a sleeve 1016 is illustrated that may be positioned around each rotatable button 104C in one embodiment of the invention. Each sleeve and rotatable button subassembly may be inserted together into the holes 113 of the top plate 102 of the master tool. The sleeve 1016 may have a shoulder 1018 that buts up against the shoulder 118 in the rotatable button 104C.

An upper cylinder of the rotatable buttons 104C is made with a smaller diameter than the openings 113 in the top plate 102 otherwise forming a gap. The sleeve 1016 fills in the gap that would otherwise be present between the openings 113 and the rotatable buttons 104C.

After machining of the cube corner patterns, the sleeves 1016 may be positioned within the openings 113 so that they are slightly protruding above the plane of corner cube tips or peaks in the background patterned surface 112 and the orientable patterned surface 114 in each rotatable button 104C.

When stamper or molds are made, the replicas of the protruding sleeves will provide a raised seal surface for attachment of a backing film that does not substantially contact or deform adjacent cube corners said arrangement providing an air gap adjacent to the cube corners.

Referring now to FIG. 10B, a top view of a portion of the master tool 100C′ is shown. The rings 1016 and the rotatable buttons 104C′ are inserted together into the holes 113 of the top plate 102 of the master tool 100C′. The rotatable buttons 104C′ have been rotated such that their pattern 114C′ has a different orientation than that of the pattern of the background patterned surface 112 of the top plate 102.

Referring now to FIG. 10C, the rings 1016 have a height that extends above the peaks of corner cubes in both the background patterned surface 112 of the top plate 112 and the orientable patterned surfaces 114C′ in the top surface of each rotatable button 104C′. The ring 1016 is used to form a sealing ring or geometry in the retro-reflective sheeting around the orientable patterned surfaces. In the case of a square cylindrical button, a triangular cylindrical button, or other geometric cylindrical button, the ring 1016 is a hollow geometric shape having plurality of walls or protrusions extending above the height of the peaks of the corner cubes to form a sealing geometric structure in retro-reflective sheeting around the orientable patterned surfaces.

The pattern of an integral raised sealing structure allows attachment of a backing sheet and adhesive while maintaining an air gap and protecting the totally internally reflecting cube corners. The raised ring 1016 used around each circular cylindrical button with a height greater than the corner cuts may be used to form circular seal around circular regions of corner cubes that may be cut into the orientable patterned surface 114C′. Alternatively, a raised ring or raised perimeter wall structure may be formed in the background patterned surface 112 around each hole 113 of the array of holes. Alternatively, a raised ring or raised perimeter wall structure may be formed in the orientable patterned surface 114 around a perimeter of each rotatable button 104. In either case, the raised ring or the raised perimeter wall structure has a height greater than a plane formed by peaks of the corner cubes.

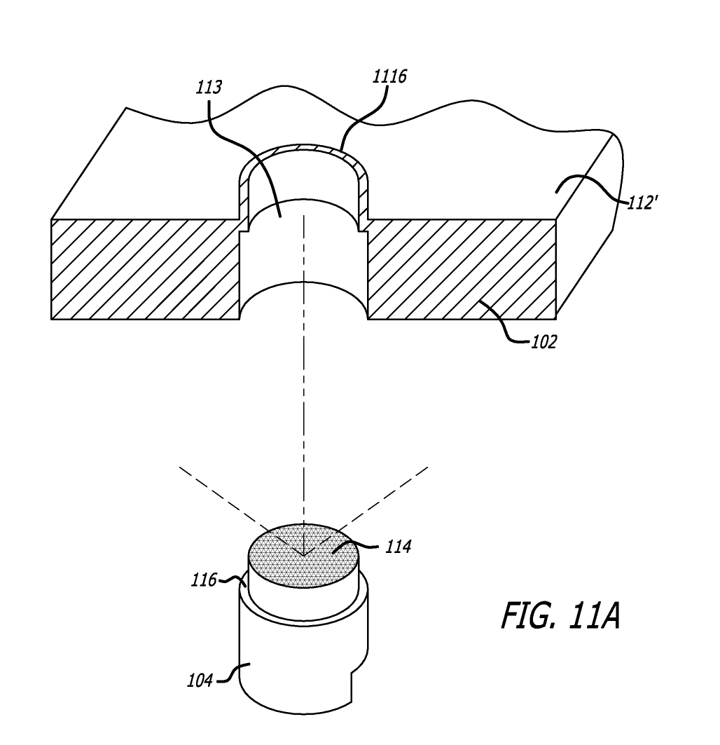

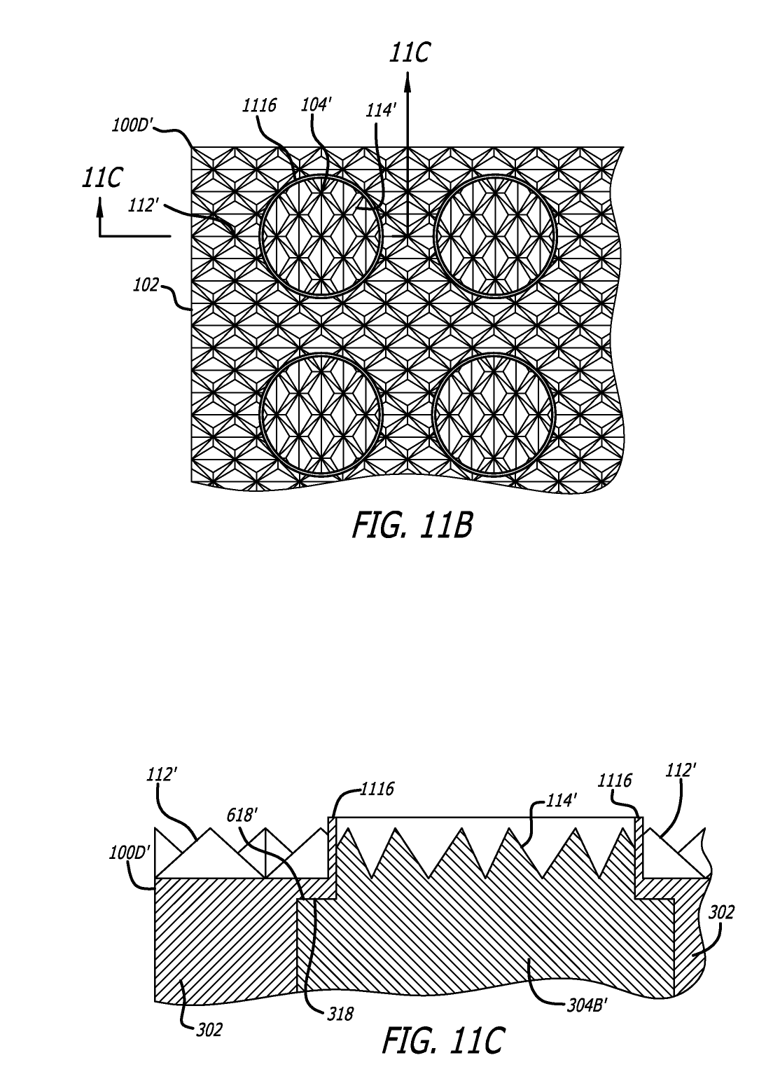

Referring now to FIGS. 11A-11C, a raised ring 1116 (or raised perimeter wall structure to include holes and buttons that are other than circular cylinders) is formed in the background patterned surface 112′ around each hole 113 of the array of holes in the top plate 102. The background patterned surface 112′ of the top plate is carefully cut so that the raised ring 1116 or the raised perimeter wall structure is periodically formed around each hole. The corner cubes are cut into the background patterned surface 112′ so that the height of the raised ring 1116 or the raised perimeter wall structure extends above the peaks of the corner cubes. The rotatable buttons 104 may be adjusted in height so that peaks of the corner cubes in the orientable surface 114 (orientable surface 114′ when rotated) are lower than the height of the raised ring 1116.

FIG. 11B illustrates a top view of a portion of the master tool 100D′ with the rotatable buttons 104 inserted into the holes 113. The background patterned surface 112′ has a raised ring 1116 around each hole and rotatable button 104′. The rotatable buttons 104′ have been rotated such that their orientable pattern surface 114′ has a different orientation than that of the pattern of the background patterned surface 112′ of the top plate 102.

Referring now to FIG. 11C, the raised ring 1116 have a height that extends above the peaks of corner cubes in both the background patterned surface 112′ of the top plate 102 and the orientable patterned surfaces 114′ in the top surface of each rotatable button 104′. The raised ring 1116 is used to form a sealing ring or geometry in the retro-reflective sheeting around the orientable patterned surfaces. In the case of a square cylindrical button, a triangular cylindrical button, or other geometric cylindrical button, the raised ring 1116 is a plurality of walls or protrusions around each hole extending above the height of the peaks of the corner cubes. The raised rings 1116 in the background patterned surface 112′ are used to form a sealing geometric structure in retro-reflective sheeting around the orientable patterned surfaces.

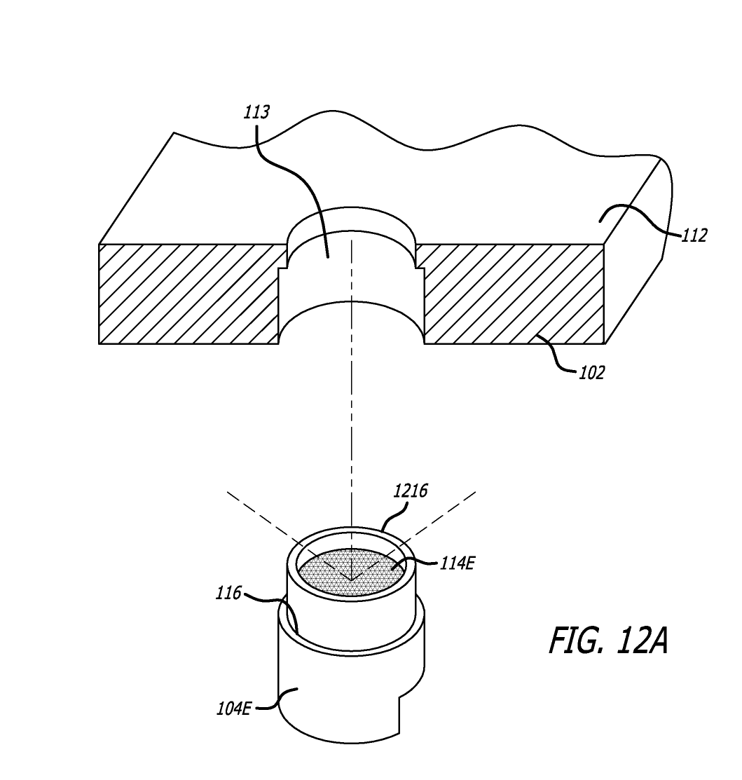

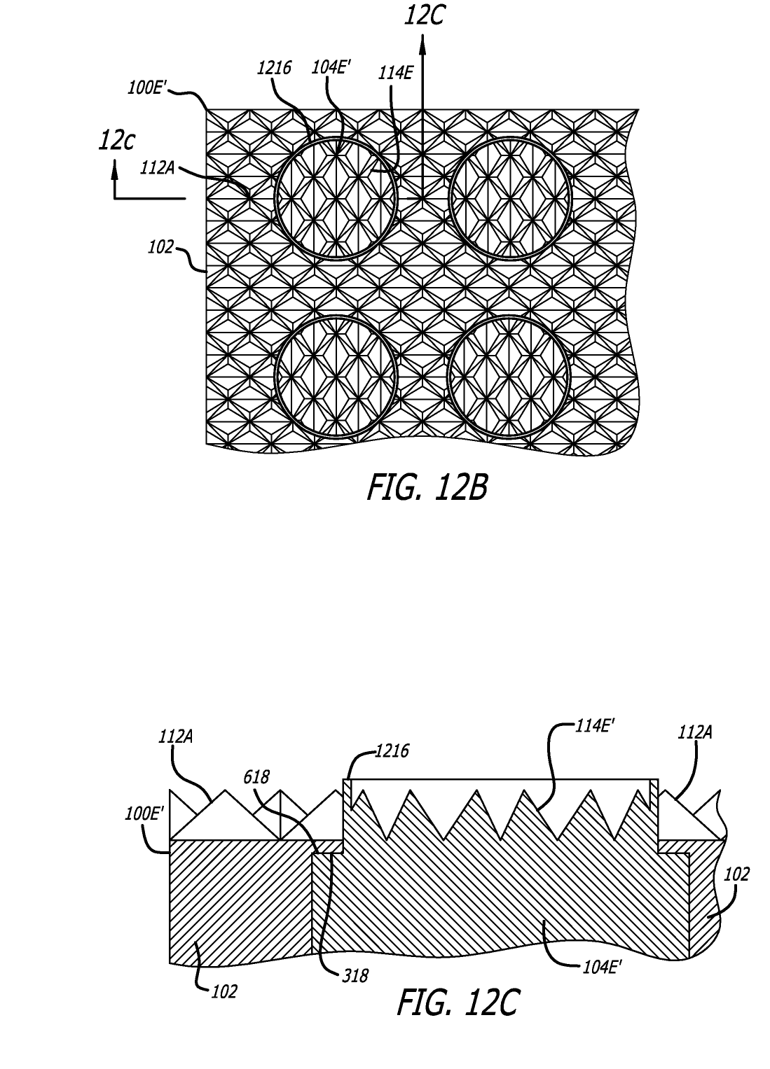

Referring now to FIGS. 12A-12C, a raised ring or raised perimeter wall structure 1216 is formed around a perimeter in the orientable patterned surface 114E of each rotatable button 104E. The orientable patterned surface 114E of each rotatable button 104E is carefully cut so that the raised ring 1216 or the raised perimeter wall structure is formed around its perimeter. The corner cubes are cut into the orientable patterned surface 114E so that the height of the raised ring 1216 or the raised perimeter wall structure extends above the peaks of the corner cubes. Corner cubes are cut into the background patterned surface 112 so that their peaks may be below a height of the raised ring 1216 or the raised perimeter wall structure in the orientable patterned surface 114E of the rotatable buttons. The rotatable buttons 104E is also adjusted in height so that the raised ring 1216 or the raised perimeter wall structure extends above the peaks of the corner cubes in the background surface 112.

FIG. 12B illustrates a top view of a portion of the master tool 100E′ with the rotatable buttons 104E′ inserted into the holes 113. The rotatable buttons 104′ have been rotated such that their orientable pattern surface 114E′ has a different orientation than that of the pattern of the background patterned surface 112 of the top plate 102. Each rotatable button 114E′ has the raised ring 1216 or the raised perimeter wall structure formed around the perimeter of the orientable patterned surface 114E′.

Referring now to FIG. 12C, a cross section of the master tool 100E illustrates how the height of the raised ring 1216 extends above the peaks of corner cubes in both the background patterned surface 112 of the top plate 102 and the orientable patterned surfaces 114E′ in the top surface of each rotatable button 104E′. The raised ring 1216 is used to form a sealing ring or geometry in the retro-reflective sheeting around the orientable patterned surfaces. In the case of a square cylindrical button, a triangular cylindrical button, or other geometric cylindrical button, the raised ring 1216 is a plurality of walls or protrusions around each the perimeter of the orientable surface in the button extending above the height of the peaks of the corner cubes. The raised rings 1216 of each rotatable button 104E′ may be used to form a sealing geometric structure in retro-reflective sheeting around the orientable patterned surfaces.

When stamper or molds are made, the raised rings or raised wall structure will form a depression such than when the retro-reflective sheeting is manufactured, an integral raised seal pattern will be formed in the surface so that an air gap is provided to the adjacent corner cubes. A backing film may be attached to the retro-reflective sheeting making contact with the raised seal pattern so that contact and/or deformation of the adjacent cube corners may be avoided.

Stampers, Die and Molds

The master tool may be considered to be male. A plurality of female replicates or replicants (e.g., stampers, die or molds) are formed from the master tool such as by an electroplating, electroforming, or metal vapor deposition process. The plurality of female replicates are then used to manufacture plastic retro-reflective sheeting by transfer of the surface pattern having the desired design, such as a corner-cube array for example.

The master tool is shown as being a square geometric shape with a twelve by twelve array of rotatable buttons. However, the master tool may have a different shape, a different size, and a different numerical array of rotatable buttons such that corresponding replicates can be made. In this manner the replicates may be oriented in multiple sub-areas, in any desired direction, and/or with any desired fractional area so as to provide a desired incident angularity pattern in retro-reflective sheeting for a particular application.

Further information regarding how the design of the master tool is used to manufacture patterned sheeting, including retro-reflective sheeting, is disclosed in U.S. provisional patent application Ser. No. 61/311,088 entitled MASTER TOOLS AND PATTERNED SHEETING WITH PERIODIC ROTATED PATTERNED REGIONS filed on Mar. 5, 2010 by David Reed et al., which was previously incorporated herein by reference.

### CONCLUSION

The human visual system is highly sensitive to even small brightness variations along lines or edges. In one embodiment of the invention, circular cylindrical rotatable buttons are used to avoid having printed letters and symbols line up with linear edges, lines, or seal patterns and cause a loss of legibility. The borders of the different orientations of cube corners in the top are defined by circular apertures rather than lines. The addition of raised ridge seal patterns, also circular in form in one embodiment of the invention, directly in the master tool avoids cosmetic defects and optical losses that may occur with a separately applied sealing pattern.

The embodiments of the invention facilitate a cost effective method of master tool fabrication. The embodiments of the invention provide freedom to design a wide variety of corner cube elements of different canting angles, orientations and area fractions into a surface. The embodiments of the invention facilitate the design of an integral seal pattern in retro-reflective sheeting.

While certain exemplary embodiments of the invention have been described and shown in the accompanying drawings, it is to be understood that such embodiments are merely illustrative of and not restrictive, and that the embodiments of the invention not be limited to the specific constructions and arrangements shown and described, since various other modifications may become apparent after reading this disclosure. For example, the master tool is described herein as being used to design and manufacture a corner cube pattern into a retro-reflective film or sheet. However, the master tool may also be used to form other types of structures or microstructures in the surface of a film or sheet of material. Rather than limiting the embodiments of the invention to the specific constructions and arrangements shown and described herein, the invention should be construed according to the following claims.

What is claimed is:

1. A master tool to transfer a surface pattern to sheeting, the master tool comprising:
a top plate having an array of openings extending from a top side to a back side and a background patterned surface in the top side;
a plurality of buttons in the array of openings in the top plate each having an orientable patterned surface near the background patterned surface, the plurality of buttons configured to be repositioned within the array of openings to selectively orient each orientable patterned surface into a different orientation with respect to the background patterned surface; and
a releasable locking mechanism to releasably lock the position of the plurality of buttons within the array of openings to hold the selected orientation of each orientable patterned surface with respect to the background patterned surface to provide a top surface pattern.

2. The master tool of claim 1, wherein
the background patterned surface includes a first pattern of a plurality of corner cubes with a first orientation; and
each orientable patterned surface includes the first pattern of the plurality of corner cubes with a second orientation different from the first orientation.

3. The master tool of claim 1, wherein
the background patterned surface includes a first pattern of a plurality of corner cubes with a first orientation; and
each orientable patterned surface includes a second pattern of a plurality of corner cubes differing from the first pattern of plurality of corner cubes
wherein a second orientation of the second pattern of plurality of corner cubes differs from the first orientation of the first pattern of plurality of corner cubes.

4. The master tool of claim 1, further comprising:
a sleeve around each of the plurality of buttons in the array of openings in the top plate, a top surface of the sleeve extending above the orientable patterned surface in each button and the background pattern surface in the top plate to transfer a sealing structure into a surface pattern of sheeting.

5. The master tool of claim 4, wherein
the background patterned surface includes a first pattern of a plurality of corner cubes with a first orientation; and
each orientable patterned surface includes the first pattern of the plurality of corner cubes with a second orientation different from the first orientation.

6. The master tool of claim 4, wherein
the background patterned surface includes a first pattern of a plurality of corner cubes with a first orientation; and
each orientable patterned surface includes a second pattern of a plurality of corner cubes differing from the first pattern of plurality of corner cubes
wherein a second orientation of the second pattern of plurality of corner cubes differs from the first orientation of the first pattern of plurality of corner cubes.

7. The master tool of claim 1, wherein
the releasable locking mechanism includes
retainers coupled to the back side of top plate under one or more bases of the plurality of buttons, the retainers configured to hold the plurality of buttons within the array of openings.

8. The master tool of claim 7, wherein
the plurality of buttons are circular cylindrical shaped rotatable buttons and the array of openings are circular cylindrical shaped holes, the circular cylindrical shaped rotatable buttons configured to rotate within the circular cylindrical shaped holes to selectively orient each orientable patterned surface into the different orientation with respect to the background patterned surface; and
the circular cylindrical shaped rotatable buttons and the retainer further configured to hold the selected orientation of the circular cylindrical shaped rotatable buttons within the array of circular cylindrical shaped holes.

9. The master tool of claim 8, wherein
each base of the circular cylindrical shaped rotatable buttons includes at least two arched shaped recesses to receive a thickness of the retainer and hold the circular cylindrical shaped rotatable buttons in two different orientations.

10. The master tool of claim 7, wherein
the plurality of buttons are cylindrical shaped buttons with a cross-section of a regular polygon and the array of openings are cylindrical shaped openings with a cross-section of the regular polygon.

11. The master tool of claim 7, further comprising:
a back plate coupled to the top plate sandwiching the plurality of buttons within the array of holes and the retainers fastened to the top plate, the back plate including a plurality of through-holes concentric with the array of holes in the top plate; and
a plurality of height adjustment bolts inserted through the through-holes and threaded into a threaded opening in each of the plurality of buttons, the plurality of height adjustment bolts configured to adjust the height of each orientable patterned surface of each button above the background patterned surface of the top plate.

12. The master tool of claim 1, wherein
the top surface pattern of the top plate is a single tile having a convex polygon shape, regular polygon shape, a kite shape, or a rhombus shape that may be replicated and tiled together across a surface of an optical material.

13. The master tool of claim 12, wherein
the top surface pattern of the top plate has the regular polygon shape of a square, an equilateral triangle, a regular pentagon, a regular hexagon, a regular heptagon, a regular octagon, a regular nonagon, or a regular decagon.

14. A method for a master tool to transfer surface patterns to sheeting, the method comprising:
inserting a plurality of buttons into an array of openings through a back side in a top plate;
forming a background patterned surface into a top side of the top plate and an orientable patterned surface into a top side of each of the plurality of buttons;
re-positioning the plurality of buttons within the array of openings to selectively orient each orientable patterned surface into a different orientation with respect to the background patterned surface; and
releasably locking the position of the plurality of buttons within the array of openings to hold the selected orientation of each orientable patterned surface with respect to the background patterned surface.

15. The method of claim 14, further comprising:
prior to re-positioning the plurality of buttons within the array of openings,
sliding a sleeve over each of the plurality of buttons with a top surface extending above the orientable patterned surface; and
inserting each subassembly of sleeve and button into the array of openings in the top plate through the back side thereof.

16. The method of claim 14, further comprising:
forming a replica of a top surface pattern of the master tool, the top surface pattern including the background patterned surface and an array of the orientable patterned surfaces.

17. The method of claim 14, wherein
the forming of the background patterned surface includes
cutting a first pattern of a plurality of corner cubes with a first orientation into a top surface of the top plate; and
the forming of the orientable patterned surface into each button includes
cutting the first pattern of the plurality of corner cubes into a top surface of each button with the first orientation.

18. The method of claim 17, wherein
the forming of the background patterned surface further includes
machining off the peaks of the plurality of corner cubes in the top surface of the top plate.

19. The method of claim 18, wherein
the forming of the orientable patterned surface into each button further includes
machining off the peaks of the plurality of corner cubes in the top surface of each button.

20. The method of claim 14, wherein
the forming of the background patterned surface includes
cutting a first pattern of a plurality of corner cubes with a first orientation into a top surface of the top plate; and
the forming of the orientable patterned surface into each button includes
cutting a second pattern of a plurality of corner cubes into a top surface of each button, the second pattern of plurality of corner cubes differing from the first pattern of plurality of corner cubes.

21. Retro-reflective sheeting comprising:
an optical material with a base surface and a top surface,
wherein the top surface has a top surface pattern transferred from a master tool, the master tool including
a top plate having an array of openings extending from a top side to a back side and a background patterned surface in the top side, wherein the background patterned surface includes a first pattern of a plurality of corner cubes with a first orientation;
a plurality of buttons in the array of openings in the top plate each having an orientable patterned surface near the background patterned surface, wherein each orientable patterned surface includes a second pattern of a plurality of corner cubes at a second orientation, the plurality of buttons configured to be repositioned within the array of openings to selectively orient each orientable patterned surface into the second orientation different than the first orientation; and
a releasable locking mechanism to releasably lock the position of the plurality of buttons within the array of openings to hold the selected orientation of each orientable patterned surface with respect to the background patterned surface to provide the top surface pattern.

22. The retro-reflective sheeting of claim 21, wherein
the first pattern of the plurality of corner cubes in the background patterned surface is substantially similar to the second pattern of the plurality of corner cubes of each button.

23. The retro-reflective sheeting of claim 21, wherein
the first pattern of the plurality of corner cubes in the background patterned surface is different from the second pattern of the plurality of corner cubes of each button.

24. The retro-reflective sheeting of claim 21, wherein
the master tool further includes
a sleeve around each of the plurality of buttons in the array of openings in the top plate, a top surface of the sleeve extending above the orientable patterned surface in each button and the background pattern surface in the top plate to transfer a sealing structure into a surface pattern of sheeting.

25. The retro-reflective sheeting of claim 24, wherein
the first pattern of the plurality of corner cubes in the background patterned surface is substantially similar to the second pattern of the plurality of corner cubes of each button.

26. The retro-reflective sheeting of claim 24, wherein
the first pattern of the plurality of corner cubes in the background patterned surface is different from the second pattern of the plurality of corner cubes of each button.

27. The retro-reflective sheeting of claim 21, wherein
the top surface pattern of the top plate is a single tile having a regular polygon shape, a kite shape, or a rhombus shape that may be replicated and tiled together across a surface of an optical material.

28. Retro-reflective sheeting comprising:
an optical material with a base surface and a top surface,
wherein the top surface of the optical material has a surface pattern transferred with the method for master tooling of claim 16.
